(19) United States
(12) Patent Application Publication
(10) Pub. No.: US 2026/0186242 A1
(43) Pub. Date: Jul. 2, 2026

(54) IMAGING OPTICAL LENS

(71) Applicant: Changzhou AAC Raytech Optronics Co., Ltd., Changzhou City (CN)

(72) Inventor: Yongqiang Yang, Changzhou (CN)

(21) Appl. No.: 19/325,479

(22) Filed: Sep. 10, 2025

Related U.S. Application Data
(63) Continuation of application No. PCT/CN2024/144582, filed on Dec. 31, 2024.

(51) Int. Cl. G02B 9/60; G02B 13/00; G02B 13/02

(52) U.S. Cl. CPC G02B 9/60; G02B 13/0045; G02B 13/02

(57) ABSTRACT

Disclosed is an imaging optical lens, the imaging optical lens includes a first prism, a first lens, a second lens with positive refractive power, a third lens with negative refractive power, a fourth lens with positive refractive power, and a fifth lens. The first lens group is movable for focus adjustment and satisfies the following relationships: 4.00≤fA/IH≤5.10; −4.00≤Rp1/Rp2≤0.71; −24.00≤f1/d1≤2.60; 0.12≤BF/TTL≤0.35 and 0.20≤f4/R8−f5/R9≤4.30.

### TECHNICAL FIELD

Embodiments of the present disclosure relate to the technical field of optics, and in particular to an imaging optical lens.

### BACKGROUND

With the rapid development and popularization of smart mobile phones, the research, development, and design of camera technology have advanced significantly. In addition, as electronic products nowadays tend to have excellent functions and a compact and lightweight design, miniaturized cameras with good imaging quality have become mainstream in the current market. Among them, inner focusing cameras, due to their characteristics such as high stability, fast focusing, good cleanliness, and the ability to address the wear issue of external focusing, have been gradually developed and applied in mobile phone cameras.

Additionally, telephoto cameras can meet consumers' needs for capturing specific targets. Traditional telephoto cameras have an excessively long total optical length, which cannot meet the lightweight and thin design requirements of smart mobile phones. However, the periscope telephoto camera design can significantly shorten the total optical length of the imaging optical lens while meeting the telephoto design. Nevertheless, the optical performance of existing periscope telephoto imaging optical lenses still cannot meet the practical requirements.

### SUMMARY

The embodiments of the present disclosure are intended to provide an imaging optical lens that can reduce the total optical length of the optical lens, meet the requirements of achieve a telephoto periscope design, and exhibit good optical performance.

In order to solve the above technical problems, the embodiments of the present disclosure provide an imaging optical lens. The imaging optical lens includes, in sequence from the object-side to the image-side:
a first prism;
a first lens;
a second lens with positive refractive power;
a third lens with negative refractive power;
a fourth lens with positive refractive power; and
a fifth lens;
a reflective surface is arranged between the object-side surface and the image-side surface of the first prism;
the first lens, the second lens, the third lens, and the fourth lens form a first lens group, and the fifth lens forms a second lens group; the first lens group is configured to be movable along the optical axis of the imaging optical lens for adjustment, enabling the imaging optical lens to switch between a first state and a second state, where the imaging optical lens has a maximum focal length in the first state and a minimum focal length in the second state;
fA represents a focal length of the imaging optical lens in the first state;
IH represents an image height of the imaging optical lens;
TTL represents a total optical length of the imaging optical lens;
Rp1 represents a curvature radius of the object-side surface of the first prism;
Rp2 represents a curvature radius of the image-side surface of the first prism;
f1 represents a focal length of the first lens;
d1 represents an on-axis thickness of the first lens;
f4 represents a focal length of the fourth lens;
R8 represents a curvature radius of the image-side surface of the fourth lens;
f5 represents a focal length of the fifth lens;
R9 represents a curvature radius of the object-side surface of the fifth lens;
BF represents an on-axis distance from the image-side surface of the fifth lens to the imaging plane of the imaging optical lens in the first state;
and the imaging optical lens satisfies the following relationships:

$$4. \leq fA / IH \leq 5.1 ;$$

$$- 4. 0 \leq Rp 1 / Rp 2 \leq 0 \text{.71} ;$$

$$- 24. 00 \leq f 1 / d 1 \leq 2.6 ;$$

$$0.12 \leq BF / TTL \leq 0 \text{.35} ;$$

$$0. 20 \leq f 4 / R 8 - f 5 / R 9 \leq 4.30 .$$

In some embodiments, the imaging optical lens satisfies the following relationships:

$$4.61 \leq fA / IH \leq 5.08 ;$$

$$- 2.6 \leq Rp 1 / Rp 2 \leq 0.71 ;$$

$$- 23.82 \leq f 1 / d 1 \leq 2.59 ;$$

$$0.14 \leq BF / TTL \leq 0 \text{.35} ;$$

$$0.21 \leq f 4 / R 8 - f 5 / R 9 \leq 4.26 .$$

In some embodiments, an object-side surface of the first prism is convex or concave in a paraxial region, fp1 represents a focal length of the first prism; and the imaging optical lens satisfies the following relationship: −27.20≤fp1/fA≤139.44.

In some embodiments, an object-side surface of the first lens is concave in a paraxial region, and an image-side surface of the first lens is convex in a paraxial region; R1 represents a curvature radius of the object-side surface of the first lens, R2 represents a curvature radius of the image-side surface of the first lens; and the imaging optical lens satisfies the following relationships: −6.94<f1/fA≤0.88; −5.98≤(R1+R2)/(R1−R2)≤2.67; 0.121≤d1/TTL≤0.154.

In some embodiments, an image-side surface of the second lens is convex in a paraxial region; f2 represents a focal length of the second lens, R3 represents a curvature radius of the object-side surface of the second lens, R4 represents a curvature radius of the image-side surface of the second lens, d3 represents an on-axis thickness of the second lens; and the imaging optical lens satisfies the following relationships: 0.21≤f2/fA≤0.40; 0.19≤(R3+R4)/(R3−R4)≤2.02; 0.06≤d3/TTL≤0.16.

In some embodiments, an object-side surface of the third lens is concave in a paraxial region, and an image-side surface of the third lens is concave in a paraxial region; f3 represents a focal length of the third lens, R5 represents a curvature radius of the object-side surface of the third lens, R6 represents a curvature radius of the image-side surface of the third lens, d5 represents an on-axis thickness of the third lens; and the imaging optical lens satisfies the following relationships: −0.34≤f3/fA≤−0.14; −0.63≤(R5+R6)/(R5−R6)≤0.44.

In some embodiments, an image-side surface of the fourth lens is convex in a paraxial region; R7 represents a curvature radius of the object-side surface of the fourth lens; d7 represents an on-axis thickness of the fourth lens; and the imaging optical lens satisfies the following relationships: 1.05≤f4/fA≤3.84; 0.40≤(R7+R8)/(R7−R8)≤4.02; 0.022≤d7/TTL≤0.057.

In some embodiments, R9 represents a curvature radius of the object-side surface of the fifth lens, R10 represents a curvature radius of the image-side surface of the fifth lens, d9 represents an on-axis thickness of the fifth lens; and the imaging optical lens satisfies the following relationships: −4.98≤f5/fA≤11.68; 3.39≤(R9+R10)/(R9−R10)≤7.27; 0.02≤d9/TTL≤0.21.

In some embodiments, the imaging optical lens has a f-number of FNO in the first state, and the imaging optical lens satisfies the following relationship: 2.07≤FNO≤2.29.

In some embodiments, the first prism is made of glass.

The beneficial effects of the embodiments of the present disclosure are as follows: By dividing the five lenses into two groups, with the front group moving for focusing, the focusing process becomes faster and smoother; at the same time, the physical length of the imaging optical lens remains unchanged, which helps allocate the device's inner space. Specifying the ratio of focal length to image height of the imaging optical lens in the first state allows the lens to have a longer focal length under a fixed image height, thereby increasing magnification. Specifying the concave-convex shapes of the first prism reduces the deflection degree of light passing through the first prism, facilitating smooth light propagation. Specifying the ratio of the focal length to the thickness of the first lens helps buffer changes in the incident angle of large-view-angle light, allowing it to propagate smoothly while maintaining the refractive power of the first lens to improve chromatic aberration and image quality. Specifying the ratio of the distance from the fifth lens to the imaging plane in the first state to the total optical length of the imaging optical lens enables the imaging optical lens to have a longer back focus while achieving miniaturization, facilitating assembly and effectively controlling its total optical length. Effectively controlling the deflection degree of the marginal field of view in the fourth lens and the fifth lens reduces the overall sensitivity of the imaging optical lens.

### BRIEF DESCRIPTION OF THE DRAWINGS

One or more embodiments are illustrated by the figures in the corresponding drawings, and these exemplified descriptions do not constitute limitations on the embodiments. Elements with the same reference numerals in the drawings represent similar elements, and the diagrams in the drawings do not constitute proportional limitations unless otherwise stated.

FIG. 1A is a schematic structural diagram of an imaging optical lens in a first embodiment of the present disclosure in the first state;

FIG. 1B is a schematic structural diagram of an imaging optical lens in a first embodiment of the present disclosure in the second state;

FIG. 2A, FIG. 3A, and FIG. 4A are respectively schematic diagrams of the field curvature and distortion, the longitudinal aberration, and the lateral color of the imaging optical lens shown in FIG. 1A;

FIG. 2B, FIG. 3B, and FIG. 4B are respectively schematic diagrams of the field curvature and distortion, the longitudinal aberration, and the lateral color of the imaging optical lens shown in FIG. 1B;

FIG. 5A is a schematic structural diagram of an imaging optical lens in a second embodiment of the present disclosure in the first state;

FIG. 5B is a schematic structural diagram of an imaging optical lens in a second embodiment of the present disclosure in the second state;

FIG. 6A, FIG. 7A, and FIG. 8A are respectively schematic diagrams of the field curvature and distortion, the longitudinal aberration, and the lateral color of the imaging optical lens shown in FIG. 5a;

FIG. 6B, FIG. 7B, and FIG. 8B are respectively schematic diagrams of the field curvature and distortion, the longitudinal aberration, and the lateral color of the imaging optical lens shown in FIG. 5b;

FIG. 9A is a schematic structural diagram of an imaging optical lens in a third embodiment of the present disclosure in the first state;

FIG. 9B is a schematic structural diagram of an imaging optical lens in a third embodiment of the present disclosure in the second state;

FIG. 10A, FIG. 11A, and FIG. 12A are respectively schematic diagrams of the field curvature and distortion, the longitudinal aberration, and the lateral color of the imaging optical lens shown in FIG. 9A;

FIG. 10B, FIG. 11B, and FIG. 12B are respectively schematic diagrams of the field curvature and distortion, the longitudinal aberration, and the lateral color of the imaging optical lens shown in FIG. 9B;

FIG. 13A is a schematic structural diagram of an imaging optical lens in a fourth embodiment of the present disclosure in the first state;

FIG. 13B is a schematic structural diagram of an imaging optical lens in a fourth embodiment of the present disclosure in the second state;

FIG. 14A, FIG. 15A, and FIG. 16A are respectively schematic diagrams of the field curvature and distortion, the longitudinal aberration, and the lateral color of the imaging optical lens shown in FIG. 13A;

FIG. 14B, FIG. 15B, and FIG. 16B are respectively schematic diagrams of the field curvature and distortion, the longitudinal aberration, and the lateral color of the imaging optical lens shown in FIG. 13B;

FIG. 17A is a schematic structural diagram of an imaging optical lens in a fifth embodiment of the present disclosure in the first state;

FIG. 17B is a schematic structural diagram of an imaging optical lens in a fifth embodiment of the present disclosure in the second state;

FIG. 18A, FIG. 19A, and FIG. 20A are respectively schematic diagrams of the field curvature and distortion, the longitudinal aberration, and the lateral color of the imaging optical lens shown in FIG. 17A;

FIG. 18B, FIG. 19B, and FIG. 20B are respectively schematic diagrams of the field curvature and distortion, the longitudinal aberration, and the lateral color of the imaging optical lens shown in FIG. 17B;

FIG. 21A is a schematic structural diagram of an imaging optical lens in a sixth embodiment of the present disclosure in the first state;

FIG. 21B is a schematic structural diagram of an imaging optical lens in a sixth embodiment of the present disclosure in the second state;

FIG. 22A, FIG. 23A, and FIG. 24A are respectively schematic diagrams of the field curvature and distortion, the longitudinal aberration, and the lateral color of the imaging optical lens shown in FIG. 21A;

FIG. 22B, FIG. 23B, and FIG. 24B are respectively schematic diagrams of the field curvature and distortion, the longitudinal aberration, and the lateral color of the imaging optical lens shown in FIG. 21B;

FIG. 25A is a schematic structural diagram of an imaging optical lens in a seventh embodiment of the present disclosure in the first state;

FIG. 25B is a schematic structural diagram of an imaging optical lens in a seventh embodiment of the present disclosure in the second state;

FIG. 26A, FIG. 27A, and FIG. 28A are respectively schematic diagrams of the field curvature and distortion, the longitudinal aberration, and the lateral color of the imaging optical lens shown in FIG. 25A;

FIG. 26B, FIG. 27B, and FIG. 28B are respectively schematic diagrams of the field curvature and distortion, the longitudinal aberration, and the lateral color of the imaging optical lens shown in FIG. 25B;

FIG. 29A is a schematic structural diagram of an imaging optical lens in an eighth embodiment of the present disclosure in the first state;

FIG. 29B is a schematic structural diagram of an imaging optical lens in an eighth embodiment of the present disclosure in the second state;

FIG. 30A, FIG. 31A, and FIG. 32A are respectively schematic diagrams of the field curvature and distortion, the longitudinal aberration, and the lateral color of the imaging optical lens shown in FIG. 29A;

FIG. 30B, FIG. 31B, and FIG. 32B are respectively schematic diagrams of the field curvature and distortion, the longitudinal aberration, and the lateral color of the imaging optical lens shown in FIG. 29B.

### DETAILED DESCRIPTION OF THE EMBODIMENTS

To make the objectives, technical solutions, and advantages of the embodiments of the present disclosure clearer, the following will describe each embodiment of the present disclosure in detail with reference to the accompanying drawings. However, those of ordinary skill in the art can understand that in each embodiment of the present disclosure, many technical details are proposed to enable readers to better understand the present disclosure. However, even without these technical details and various changes and modifications based on the following embodiments, the technical solutions claimed in the present disclosure can still be realized.

In the embodiments of the present disclosure, terms such as “upper”, “lower”, “left”, “right”, “front”, “rear”, “top”, “bottom”, “inner”, “outer”, “middle”, “vertical”, “horizontal”, “transverse”, and “longitudinal” indicate orientations or positional relationships based on the orientations or positional relationships shown in the drawings. These terms are mainly used to better describe the present disclosure and its embodiments, and are not intended to limit the indicated devices, elements, or components to have specific orientations or to be constructed and operated in specific orientations.

In addition, some of the above terms may also be used to indicate other meanings besides orientations or positional relationships. For example, the term “upper” may also be used to indicate a certain attachment or connection relationship in some cases. For those of ordinary skill in the art, the specific meanings of these terms in the present disclosure can be understood according to specific situations.

Moreover, the terms “installation”, “setting”, “providing”, “opening”, “connection”, and “connection” should be interpreted broadly. For example, it may be a fixed connection, a detachable connection, or an integral structure; it may be a mechanical connection or an electrical connection; it may be a direct connection or an indirect connection through an intermediate medium, or it may be internal communication between two devices, elements, or components. For those of ordinary skill in the art, the specific meanings of the above terms in the present disclosure can be understood according to specific situations.

In addition, the terms “first” and “second” are mainly used to distinguish different devices, elements, or components (the specific types and structures may be the same or different), and are not used to indicate or imply the relative importance and quantity of the indicated devices, elements, or components. Unless otherwise specified, “multiple” means two or more.

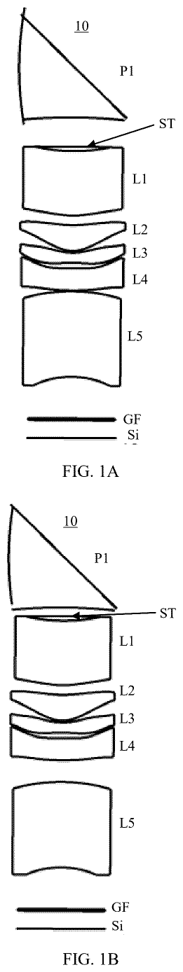

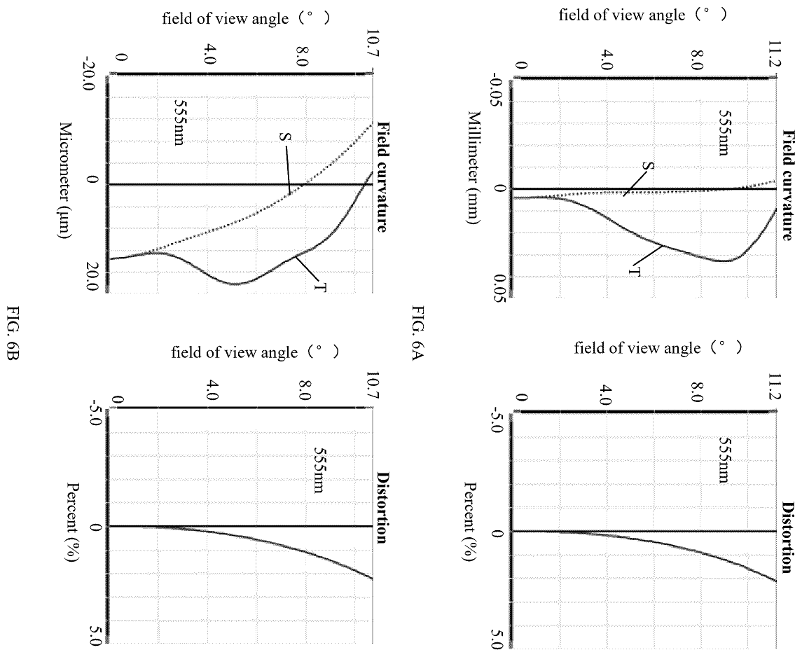

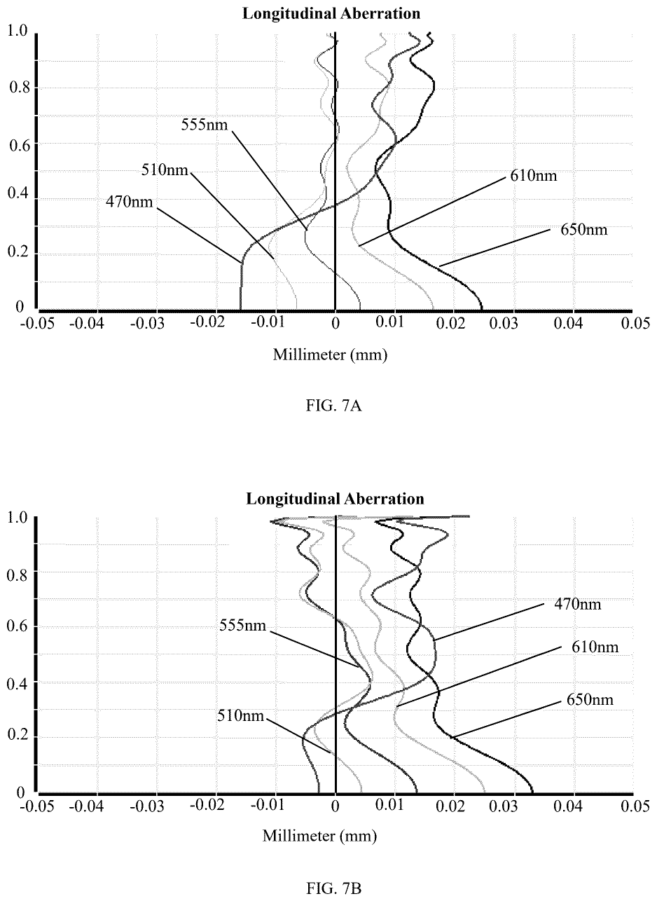

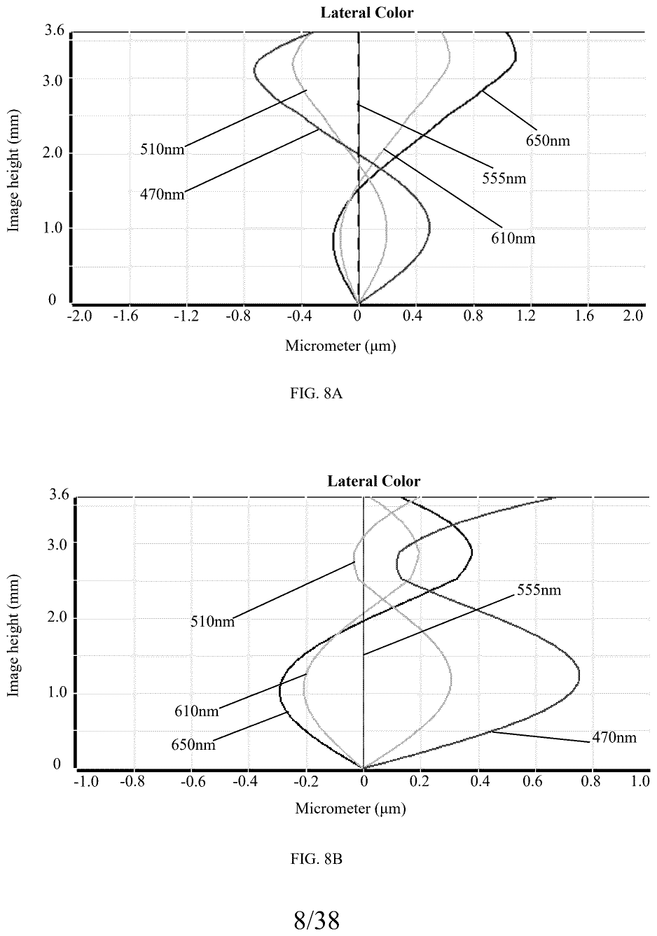

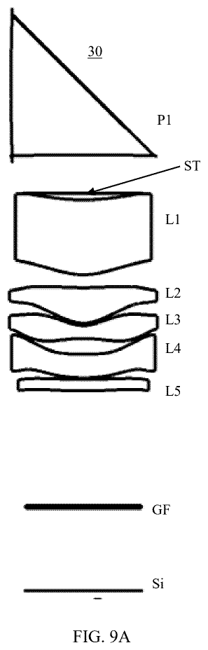

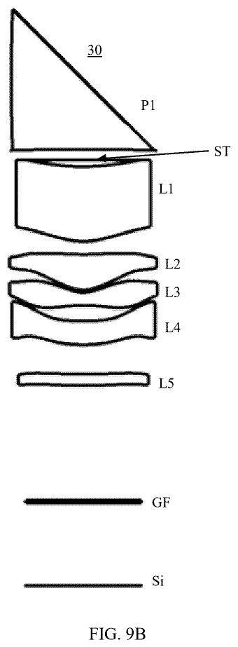

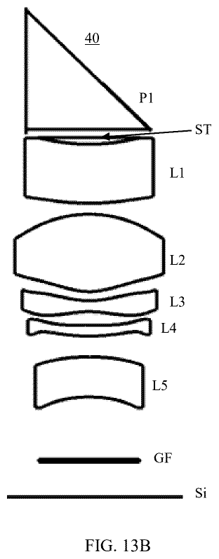

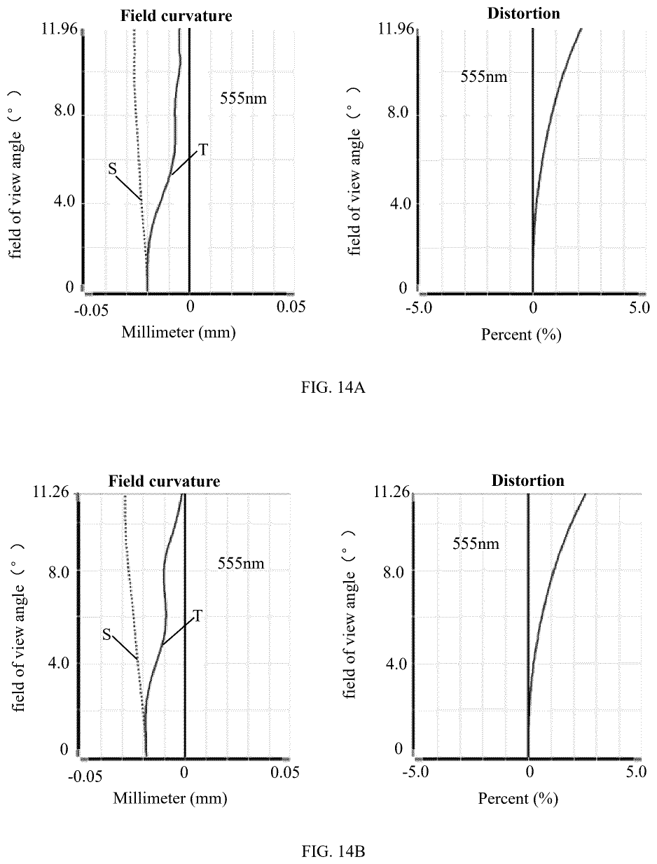

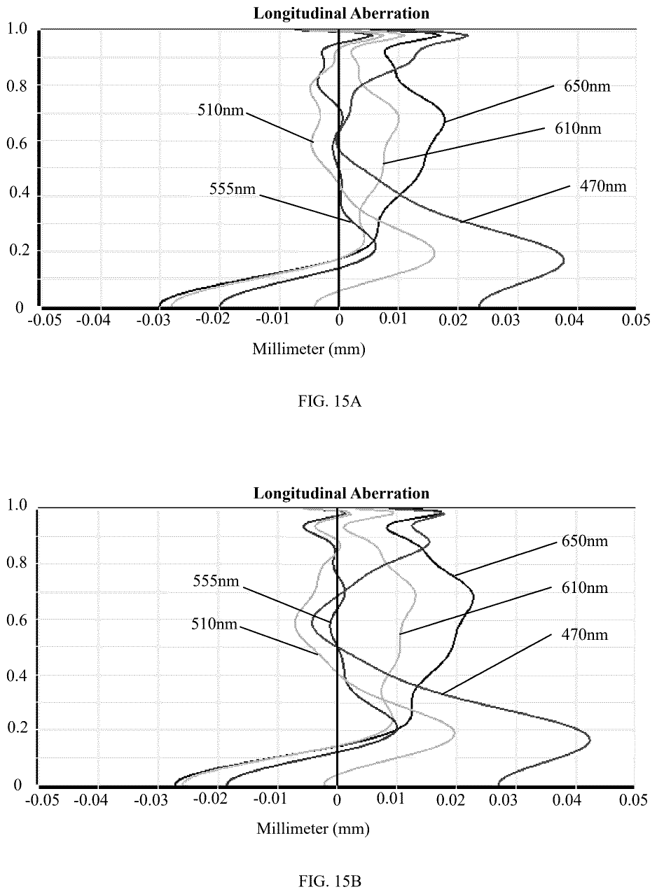

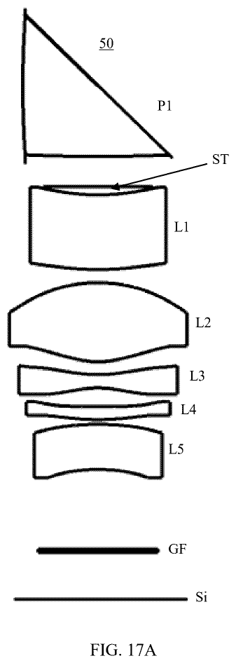

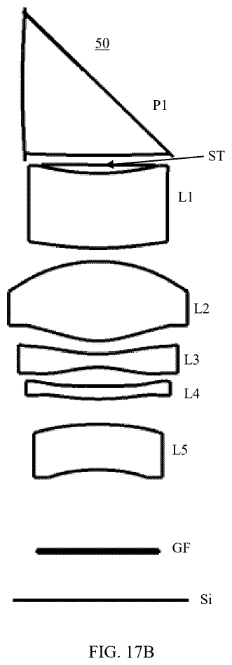

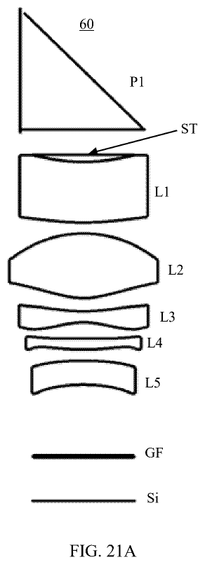

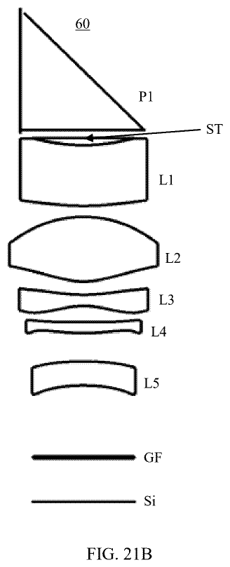

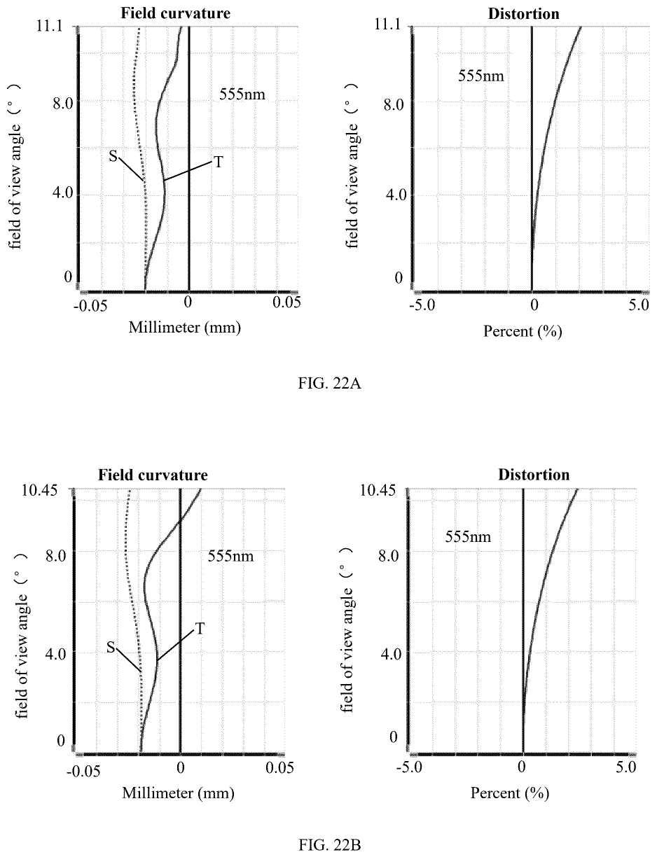

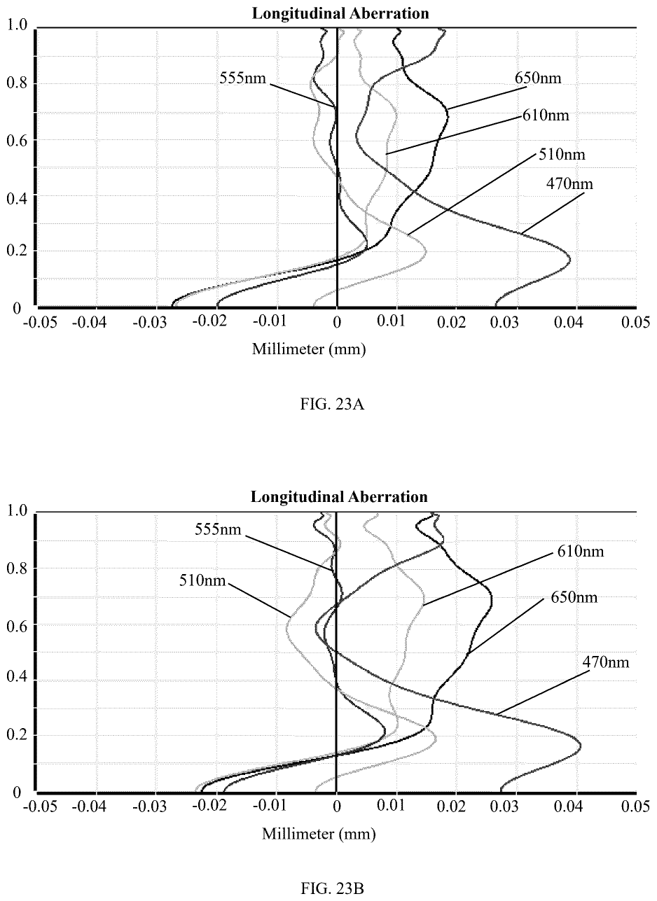

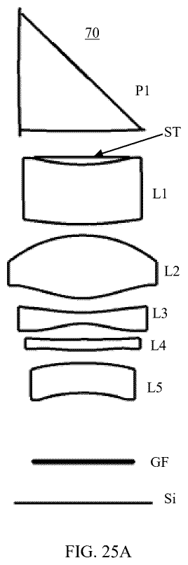

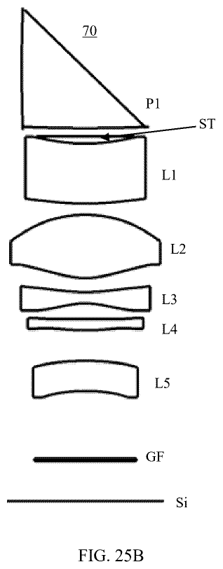

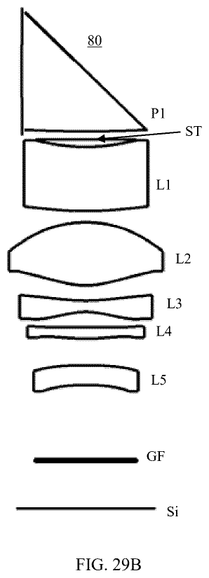

Referring to FIG. 1A, FIG. 1B, FIG. 5A, FIG. 5B, FIG. 9A, FIG. 9B, FIG. 13A, FIG. 13B, FIG. 17A, FIG. 17B, FIG. 21A, FIG. 21B, FIG. 25A, FIG. 25B, FIG. 29A, and FIG. 29B, the technical solution of the present disclosure provides imaging optical lenses 10, 20, 30, 40, 50, 60, 70, and 80. The imaging optical lenses 10, 20, 30, 40, 50, 60, 70, and 80 each include, in sequence from the object-side to the image-side: a first prism P1, a first lens L1, a second lens L2 with positive refractive power, a third lens L3 with negative refractive power, a fourth lens L4 with positive refractive power, and a fifth lens L5. A reflective surface is arranged between the object-side surface and the image-side surface of the first prism P1. The first lens L1, the second lens L2, the third lens L3, and the fourth lens L4 form a first lens group, while the fifth lens L5 forms a second lens group. The first lens group is configured to be movable along the optical axis of the imaging optical lenses 10, 20, 30, 40, 50, 60, 70, and 80 for adjustment, enabling the imaging optical lenses 10, 20, 30, 40, 50, 60, 70, and 80 to switch between a first state and a second state. In the first state, the imaging optical lenses 10, 20, 30, 40, 50, 60, 70, and 80 have a maximum focal length, while in the second state, the imaging optical lenses 10, 20, 30, 40, 50, 60, 70, and 80 have a minimum focal length.

A focal length of the imaging optical lenses 10, 20, 30, 40, 50, 60, 70, and 80 in the first state is defined as fA, an image height of the imaging optical lenses 10, 20, 30, 40, 50, 60, 70, and 80 is defined as IH, a total optical length of the imaging optical lenses 10, 20, 30, 40, 50, 60, 70, and 80 is defined as TTL, a curvature radius of the object-side surface of the first prism P1 is defined as Rp1, a curvature radius of the image-side surface of the first prism P1 is defined as Rp2, a focal length of the first lens is defined as f1, an on-axis thickness of the first lens L1 is defined as d1, a focal length of the fourth lens is defined as f4, a curvature radius of the image-side surface of the fourth lens is defined as R8, a focal length of the fifth lens is defined as f5, a curvature radius of the object-side surface of the fifth lens is defined as R9, an on-axis distance from the image-side surface of the fifth lens to the imaging plane of the imaging optical lens in the first state is defined as BF, and the following relationship formulas should be satisfied:

$$4. \leq fA / IH \leq 5.1 \qquad ( 1 )$$

$$- 4. \leq Rp 1 / Rp 2 \leq 0.71 \qquad ( 2 )$$

$$- 24. \leq f 1 / d 1 \leq 2.6 \qquad ( 3 )$$

$$0.12 \leq BF / TTL \leq 0.35 \qquad ( 4 )$$

$$0. 20 \leq f 4 / R 8 - f 5 / R 9 \leq 4.30 . \qquad ( 5 )$$

The imaging optical lenses 10, 20, 30, 40, 50, 60, 70, and 80 are periscope optical lenses, each including five lenses. The five lenses of the imaging optical lenses 10, 20, 30, 40, 50, 60, 70, and 80 are the first lens L1, second lens L2, third lens L3, fourth lens L4, and fifth lens L5. These five lenses are divided into two groups (the two lenses+the three lenses), namely the first lens group and the second lens group, with the first lens group positioned closer to the object-side than the second lens group.

The first lens group is a front group, including the first lens L1, the second lens L2, the third lens L3, and the fourth lens L4. The object-side surface of the first lens group is the object-side surface of the first lens L1, and the image-side surface of the first lens group is the image-side surface of the fourth lens L4. The second lens group is a rear group, including the fifth lens L5. The object-side surface of the second lens group is the object-side surface of the fifth lens L5, and the image-side surface of the second lens group is the image-side surface of the fifth lens L5.

The first lens group is arranged between the first prism P1 and the second lens group and is configured to move along the optical axis of the imaging optical lenses 10, 20, 30, 40, 50, 60, 70, and 80, thereby adjusting the on-axis distance from the image-side surface of the first prism P1 to the object-side surface of the first lens group and the on-axis distance from the image-side surface of the first lens group to the object-side surface of the second lens group. Thus, the first lens group acts as a moving zoom group, while the second lens group serves as a fixed focal length group. The movement of the first lens group enables focal length changes of the imaging optical lenses 10, 20, 30, 40, 50, 60, 70, and 80, ensuring good imaging performance in both the first state and the second state. The first state refers to the state where the imaging optical lenses 10, 20, 30, 40, 50, 60, 70, and 80 have a maximum focal length, and the second state refers to the state where they have a minimum focal length. For example, the first state may be a telephoto state or an infinite object-distance state; the second state may be a short-focus state, a macro state, or a state with an object distance of 200 mm. Thus, the imaging optical lenses 10, 20, 30, 40, 50, 60, 70, and 80 can achieve inner focusing through the movement of the front group.

The Relationship formula (1) specifies the ratio range of the focal length fA in the first state to the image height (IH) of the imaging optical lenses 10, 20, 30, 40, 50, 60, 70, and 80. Within the range defined by the relationship formula (1), the imaging optical lenses 10, 20, 30, 40, 50, 60, 70, and 80 have a longer focal length under a fixed image height (IH), it helps to improve the magnification of the imaging optical lenses 10, 20, 30, 40, 50, 60, 70, and 80. More preferably, 4.61≤fA/IH≤5.08.

The relationship formula (2) specifies the ratio range of the curvature radius Rp1 of the object-side surface of the first prism P1 to the curvature radius Rp2 of the image-side surface of the first prism P1, controlling the concave-convex shapes of the object-side surface and the image-side surface of the first prism P1. Within the range defined by the relationship formula (2), it is beneficial to reduce the deflection degree of light passing through the first prism P1, facilitating its subsequent smooth propagation. More preferably, −2.60≤Rp1/Rp230.71.

The relationship formula (3) specifies the ratio range of the focal length f1 of the first lens L1 to the on-axis thickness d1 of the first lens L1. Within the range defined by the relationship formula (3), it helps buffer changes in the incident angle of large-view-angle light, allowing it to propagate smoothly in the imaging optical lenses 10, 20, 30, 40, 50, 60, 70, and 80. Meanwhile, it maintains the refractive power of the first lens L1 to improve chromatic aberration and enhance imaging quality. More preferably, −23.82≤f1/d1≤2.59.

The relationship formula (4) specifies the ratio range between the shortest on-axis distance BF from the image-side surface of the fifth lens L5 to the imaging plane Si in the first state and the total optical length TTL of the imaging optical lenses 10, 20, 30, 40, 50, 60, 70, and 80. Within the range defined by relational formula (4), the imaging optical lenses 10, 20, 30, 40, 50, 60, 70, and 80 can achieve miniaturization while maintaining a sufficient back focus, which facilitates their assembly and effectively controls their total length. More preferably, 0.14≤BF/TTL≤0.35.

The relationship formula (5) specifies the value range of f4/R8−f5/R9. Within the range defined by relational formula (5), the deflection degree of the marginal field of view in the fourth lens L4 and the fifth lens L5 can be effectively controlled, thereby reducing the overall sensitivity of the imaging optical lenses 10, 20, 30, 40, 50, 60, 70, and 80. More preferably, 0.21≤f4/R8−f5/R9≤4.26.

The beneficial effects of the present disclosure are as follows: By dividing the five lenses into two groups, with the front group moving for focusing, the focusing process becomes faster and smoother; at the same time, the physical length of the imaging optical lenses 10, 20, 30, 40, 50, 60, 70, and 80 remains unchanged, which helps allocate the device's inner space. Specifying the ratio of focal length to image height of the imaging optical lenses 10, 20, 30, 40, 50, 60, 70, and 80 in the first state allows the lenses to have a longer focal length under a fixed image height, thereby increasing magnification. Optimizing the concave-convex shapes of the first prism P1 reduces the deflection degree of light passing through the first prism P1, facilitating smooth light propagation. Specifying the ratio of the focal length to the thickness of the first lens L1 helps buffer changes in the incident angle of large-view-angle light, allowing it to propagate smoothly while maintaining the refractive power of the first lens L1 to improve chromatic aberration and image quality. Specifying the ratio of the distance from the fifth lens L5 to the imaging plane in the first state to the total optical length of the imaging optical lenses enables the imaging optical lenses 10, 20, 30, 40, 50, 60, 70, and 80 to have a longer back focus while achieving miniaturization, facilitating assembly and effectively controlling their total optical length. Effectively controlling the deflection degree of the marginal field of view in the fourth lens L4 and the fifth lens L5 reduces the overall sensitivity of the imaging optical lenses 10, 20, 30, 40, 50, 60, 70, and 80.

Based on the above relationships and achievable functions, the characteristics of each of the lenses are further detailed as follows.

Preferably, the focal length of the first prism P1 is fp1, and the sum of the on-axis distance from the object-side surface of the first prism P1 to the reflective surface and the on-axis distance from the reflective surface to the image-side surface of the first prism P1 is defined as dp1. The following relationship formulas should be satisfied:

$$- 27.2 \leq fp 1 / fA \leq 13 \; 9 \text{.44} \qquad ( 6 )$$

$$0.244 \leq dp 1 / TTL \leq 0.246 . \qquad ( 7 )$$

The relationship formula (6) specifies the ratio range of the focal length fp1 of the first prism P1 to the focal length fA of the imaging optical lenses 10, 20, 30, 40, 50, 60, 70, and 80 in the first state. Within the range defined by the relationship formula (6), it is beneficial to improve the optical performance of the imaging optical lenses 10, 20, 30, 40, 50, 60, 70, and 80.

The relationship formula (7) specifies the ratio range of the total on-axis thickness dp1 of the first prism P1 to the total optical length TTL of the imaging optical lenses 10, 20, 30, 40, 50, 60, 70, and 80. Within the range defined by relationship (7), it is beneficial to control the total optical length TTL of the imaging optical lenses 10, 20, 30, 40, 50, 60, 70, and 80, facilitating the miniaturized design of the imaging optical lenses 10, 20, 30, 40, 50, 60, 70, and 80.

An object-side surface of the first prism P1 is convex or concave in a paraxial region, and an image-side surface of the first prism P1 is concave, convex, or planar in a paraxial region. The object-side surface and the image-side surface of the first prism P1 may be configured with other concave and convex distributions.

Preferably, a curvature radius of the object-side surface of the first lens L1 is defined as R1, and a curvature radius of the image-side surface of the first lens L1 is defined as R2. The following relationship formula should be satisfied:

$$- 6.94 \leq f 1 / fA \leq 0 \text{.88} \qquad ( 8 )$$

$$- 5.98 \leq ( R 1 + R 2 ) / ( R 1 - R 2 ) \leq 2.67 \qquad ( 9 )$$

$$0.121 \leq d 1 / TTL \leq 0.1 54. \qquad ( 10 )$$

The relationship formula (8) specifies the ratio range of the focal length f1 of the first lens L1 to the focal length fA of the imaging optical lenses 10, 20, 30, 40, 50, 60, 70, and 80 in the first state. Within the range defined by the relationship formula (8), by controlling the negative refractive power of the first lens L1 within a reasonable range, it is beneficial to correct aberrations of the optical system.

The relationship formula (9) specifies the concave-convex shapes of the object-side surface and the image-side surface of the first lens L1. Within the range defined by relationship (9), even as the imaging optical lenses 10, 20, 30, 40, 50, 60, 70, and 80 develop toward miniaturization, it is beneficial to correct axial chromatic aberrations.

The relationship formula (10) specifies the ratio range of the on-axis thickness d1 of the first lens L1 to the total optical length TTL of the imaging optical lenses 10, 20, 30, 40, 50, 60, 70, and 80. Within the range defined by relationship (10), it is beneficial to control the total optical length TTL of the imaging optical lenses 10, 20, 30, 40, 50, 60, 70, and 80, facilitating the miniaturized design of the imaging optical lenses 10, 20, 30, 40, 50, 60, 70, and 80.

The object-side surface of the first lens L1 is concave in a paraxial region, and the image-side surface of the first lens L1 is convex in a paraxial region. The object-side surface and the image-side surface of the first lens L1 may be configured with other concave and convex distributions.

Preferably, a focal length of the second lens L2 is f2, a curvature radius of the object-side surface of the second lens L2 is defined as R3, a curvature radius of the image-side surface of the second lens L2 is defined as R4, and an on-axis thickness of the second lens L2 is defined as d3. The following relationship formulas should be satisfied:

$$0.21 \leq f 2 / fA \leq 0. 40 \qquad ( 11 )$$

$$0.19 \leq ( R 3 + R 4 ) / ( R 3 - R 4 ) \leq 2 \text{.02} \qquad ( 12 )$$

$$0.06 \leq d 3 / TTL \leq 0 \text{.16} . \qquad ( 13 )$$

The relationship formula (11) specifies the ratio range of the focal length f2 of the second lens L2 to the focal length fA of the imaging optical lenses 10, 20, 30, 40, 50, 60, 70, and 80 in the first state. Within the range defined by relationship (11), it is beneficial to correct aberrations of the optical system and improve the imaging quality of the imaging optical lenses 10, 20, 30, 40, 50, 60, 70, and 80.

The relationship formula (12) specifies the concave-convex shapes of the object-side surface and the image-side surface of the second lens L2. Within the range defined by relationship (12), even as the imaging optical lenses 10, 20, 30, 40, 50, 60, 70, and 80 develop toward miniaturization, it is beneficial to correct axial chromatic aberrations.

The relationship formula (13) specifies the ratio range of the on-axis thickness d3 of the second lens L2 to the total optical length TTL of the imaging optical lenses 10, 20, 30, 40, 50, 60, 70, and 80. Within the range defined by relationship (13), it is beneficial to control the total optical length TTL of the imaging optical lenses 10, 20, 30, 40, 50, 60, 70, and 80, realizing the miniaturization design of the imaging optical lenses 10, 20, 30, 40, 50, 60, 70, and 80.

The object-side surface of the second lens L2 is convex or concave in a paraxial region, and the image-side surface of the second lens L2 is convex in a paraxial region. The object-side surface and the image-side surface of the second lens L2 may be configured with other concave and convex distributions.

Preferably, a focal length of the third lens L3 is f3, a curvature radius of the object-side surface of the third lens L3 is defined as R5, a curvature radius of the image-side surface of the third lens L3 is defined as R6, and an on-axis thickness of the third lens L3 is defined as d6. The following relationship formulas should be satisfied:

$$- 0.34 \leq f 3 / fA \leq - 0 \text{.14} \qquad ( 14 )$$

$$- 0.63 \leq ( R 5 + R 6 ) / ( R 5 - R 6 ) \leq 0.44 \qquad ( 15 )$$

$$0.022 \leq d 5 / TTL \leq 0.0 27. \qquad ( 16 )$$

The relationship formula (14) specifies the ratio range of the focal length f3 of the third lens L3 to the focal length fA of the imaging optical lenses 10, 20, 30, 40, 50, 60, 70, and 80 in the first state. Within the range defined by relationship (14), through reasonable distribution of refractive power, the system has better imaging quality and lower sensitivity.

The relationship formula (15) specifies the concave-convex shapes of the object-side surface and the image-side surface of the third lens L3. Within the range defined by relationship (15), the deflection degree of light passing through the third lens L3 can be reduced, thereby effectively reducing aberrations.

The relationship formula (16) specifies the ratio range of the on-axis thickness d5 of the third lens L3 to the total optical length TTL of the imaging optical lenses 10, 20, 30, 40, 50, 60, 70, and 80. Within the range defined by relationship (16), it is beneficial to control the total optical length TTL of the imaging optical lenses 10, 20, 30, 40, 50, 60, 70, and 80, facilitating the miniaturized design of the imaging optical lenses 10, 20, 30, 40, 50, 60, 70, and 80.

The object-side surface of the third lens L3 is concave in a paraxial region, and the image-side surface of the third lens L3 is concave in a paraxial region. The object-side surface and the image-side surface of the third lens L3 may be configured with other concave and convex distributions.

Preferably, a curvature radius of the object-side surface of the fourth lens L4 is defined as R7, and an on-axis thickness of the fourth lens L4 is defined as d7. The following relationship formulas should be satisfied:

$$1. 05 \leq f 4 / fA \leq 3.84 \qquad ( 17 )$$

$$0.4 \leq ( R 7 + R 8 ) / ( R 7 - R 8 ) \leq 4 \text{.02} \qquad ( 18 )$$

$$0.022 \leq d 7 / TTL \leq 0.0 57. \qquad ( 19 )$$

The relationship formula (17) specifies the ratio range of the focal length f4 of the fourth lens L4 to the focal length fA of the imaging optical lenses 10, 20, 30, 40, 50, 60, 70, and 80 in the first state. Within the range defined by relationship (17), through reasonable distribution of refractive power, the system has better imaging quality and lower sensitivity.

The relationship formula (18) specifies the concave-convex shapes of the object-side surface and the image-side surface of the fourth lens L4. Within the range defined by relationship (18), the deflection degree of light passing through the fourth lens L4 can be reduced, thereby effectively reducing aberrations.

The relationship formula (19) specifies the ratio range of the on-axis thickness d7 of the fourth lens L4 to the total optical length TTL of the imaging optical lenses 10, 20, 30, 40, 50, 60, 70, and 80. Within the range defined by relationship (19), it is beneficial to control the total optical length TTL of the imaging optical lenses 10, 20, 30, 40, 50, 60, 70, and 80, facilitating the miniaturized design of the imaging optical lenses 10, 20, 30, 40, 50, 60, 70, and 80.

An object-side surface of the fourth lens L4 is convex or concave in a paraxial region, and an image-side surface of the fourth lens L4 is convex in a paraxial region. The object-side surface and the image-side surface of the fourth lens L4 may be configured with other concave and convex distributions.

Preferably, the curvature radius of the object-side surface of the fifth lens L5 is defined as R9, the curvature radius of the image-side surface of the fifth lens L5 is defined as R10, and the on-axis thickness of the fifth lens L5 is defined as d9. The following relationship formulas should be satisfied:

$$- 4.98 \leq f 5 / fA \leq 11.68 \qquad ( 20 )$$

$$3.39 \leq ( R 9 + R 10 ) / ( R 9 - R 10 ) \leq 7.27 \qquad ( 21 )$$

$$0.02 \leq d 9 / TTL \leq 0.21 . \qquad ( 22 )$$

The relationship formula (20) specifies the ratio range of the focal length f5 of the fifth lens L5 to the focal length fA of the imaging optical lenses 10, 20, 30, 40, 50, 60, 70, and 80 in the first state. Within the range defined by relationship (20), the light incident angle of the imaging optical lenses 10, 20, 30, 40, 50, 60, 70, and 80 is moderated, thereby reducing tolerance sensitivity.

The relationship formula (21) specifies the concave-convex shapes of the object-side surface and the image-side surface of the fifth lens L5. Within the range defined by relationship (21), as the imaging optical lenses 10, 20, 30, 40, 50, 60, 70, and 80 are miniaturized, it helps correct the issue of axial chromatic aberration.

The relationship formula (22) specifies the ratio range of the on-axis thickness d9 of the fifth lens L5 to the total optical length TTL of the imaging optical lenses 10, 20, 30, 40, 50, 60, 70, and 80. Within the range defined by relationship (22), it is beneficial to control the total optical length TTL of the imaging optical lenses 10, 20, 30, 40, 50, 60, 70, and 80, facilitating the miniaturized design of the imaging optical lenses 10, 20, 30, 40, 50, 60, 70, and 80.

An object-side surface of the fifth lens L5 is convex or concave in a paraxial region, and an image-side surface of the fifth lens L5 is concave or convex in a paraxial region. The object-side surface and the image-side surface of the fifth lens L5 may be configured with other concave and convex distributions.

Preferably, the f-number of the imaging optical lenses 10, 20, 30, 40, 50, 60, 70, and 80 in the first state is FNO, and the following relationship formulas should be satisfied:

$$2.07 \leq FNO \leq 2.29 \qquad ( 23 )$$

The relationship formula (23) specifies the f-number FNO of the imaging optical lenses 10, 20, 30, 40, 50, 60, 70, and 80. Within the range defined by relationship (23), it can ensure that the imaging optical lenses 10, 20, 30, 40, 50, 60, 70, and 80 have a large aperture.

In the present disclosure, the first prism P1 is made of glass, while the first lens L1, the second lens L2, the third lens L3, the fourth lens L4, and the fifth lens L5 are made of plastic. In other alternative arrangements, the first prism P1 and each of the lenses may be made of other materials.

In the present disclosure, an optical filter GF and other optical elements are arranged between the fifth lens L5 and the imaging surface Si, where the optical filter GF can be a glass cover plate or an optical filter. In other alternative arrangements, the optical filter GF may be arranged at other positions.

In the present disclosure, an aperture ST may also be arranged between the first prism P1 and the first lens L1.

The imaging optical lenses 10, 20, 30, 40, 50, 60, 70, and 80 of the present disclosure will be described below with examples. The symbols recorded in each example are as shown in Table 1, and the units of focal length, on-axis distance, curvature radius, and on-axis thickness are millimeters.

TTL: Total optical length (the on-axis distance from the object-side surface of the first prism P1 to the imaging plane Si), in millimeters.

### First Embodiment

The first prism P1, has positive refractive power, with its object-side surface being convex in the paraxial region and its image-side surface being concave in the paraxial region;

The first lens, L1, has positive refractive power, with its object-side surface being concave in the paraxial region and its image-side surface being convex in the paraxial region;

The second lens L2, has positive refractive power, with its object-side surface being concave in the paraxial region and its image-side surface being convex in the paraxial region;

The third lens L3, has negative refractive power, with its object-side surface being concave in the paraxial region and its image-side surface being concave in the paraxial region;

The fourth lens LA, has positive refractive power, with its object-side surface being concave in the paraxial region and its image-side surface being convex in the paraxial region;

The fifth lens L5, has negative refractive power, with its object-side surface being convex in the paraxial region and its image-side surface being concave in the paraxial region.

FIGS. 1A and 1B are schematic structural diagrams of the imaging optical lens 10 in the first embodiment. The following shows the design data of the imaging optical lens 10 in the first embodiment of the present disclosure.

Table 1 lists the curvature radius Rp of the object-side surface and image-side surface, the on-axis thickness of the lens, the on-axis distance d between lenses, the refractive index nd, and the Abbe number vd of the first prism P1 to the fifth lens L5 constituting the imaging optical lens 10 in the first embodiment of the present disclosure. It should be noted that in this embodiment, the units of distance, radius, and thickness are all millimeters (mm).

TABLE 1

| | R | d | | nd | | vd | |
|---|---|---|---|---|---|---|---|
| ST | ∞ | d0= | d0 | | | | |
| Rp1 | 31.942 | dp1= | 9.800 | nd1 | 1.8052 | vd1 | 40.91 |
| Rp2 | 46.093 | dp2= | dp2 | | | | |
| R1 | −16.347 | d1= | 6.065 | nd2 | 1.6400 | vd2 | 23.54 |
| R2 | −7.161 | d2= | 0.900 | | | | |
| R3 | −8.055 | d3= | 2.427 | nd3 | 1.5444 | vd3 | 55.82 |
| R4 | −2.713 | d4= | 0.170 | | | | |
| R5 | −6.013 | d5= | 0.950 | nd4 | 1.6153 | vd4 | 25.94 |
| R6 | 10.305 | d6= | 0.538 | | | | |
| R7 | −32.786 | d7= | 2.062 | nd5 | 1.6700 | vd5 | 19.39 |
| R8 | −19.701 | d8= | d8 | | | | |
| R9 | 15.612 | d9= | 8.046 | nd6 | 1.5346 | vd6 | 55.69 |
| R10 | 8.515 | d10= | 3.891 | | | | |
| R11 | ∞ | d11= | 0.210 | ndg | 1.5168 | vdg | 64.17 |
| R12 | ∞ | d12= | 1.666 | | | | |

Herein, dp1=“dp1-01”+“dp1-02”, where “dp1-01”=5.0 and “dp1-02”=4.8.

Table 2 lists relevant optical parameters of the imaging optical lens 10 in the first embodiment of the present disclosure in the first state and the second state respectively.

TABLE 2

| | In the first state | In the second state |
|---|---|---|
| f | 17.908 | 17.039 |
| FOV | 22.29° | 21.22° |
| FNO | 2.24 | 2.34 |
| d0 | −12.558 | −10.623 |
| dp2 | 3.175 | 1.240 |
| d8 | 0.100 | 2.035 |

The meanings of the symbols in the above table are as follows:
R: the curvature radius of the optical surface, or the central curvature radius for lenses;
ST: aperture;
Rp1: the curvature radius of the object-side surface of the first prism P1;
Rp2: the curvature radius of the image-side surface of the first prism P1;
R1: the curvature radius of the object-side surface of the first lens L1;
R2: the curvature radius of the image-side surface of the first lens L1;
R3: the curvature radius of the object-side surface of the second lens L2;
R4: the curvature radius of the image-side surface of the second lens L2;
R5: the curvature radius of the object-side surface of the third lens L3;
R6: the curvature radius of the image-side surface of the third lens L3;
R7: the curvature radius of the object-side surface of the fourth lens L4;
R8: the curvature radius of the image-side surface of the fourth lens L4;
R9: the curvature radius of the object-side surface of the fifth lens L5;
R10: the curvature radius of the image-side surface of the fifth lens L5;
R11: the curvature radius of the object-side surface of the optical filter GF;
R12: the curvature radius of the image-side surface of the optical filter GF;
d: the on-axis thickness of the lens, or on-axis distance between lenses;
d0: the on-axis distance from the aperture ST to the object-side surface of the first prism P1;
dp1: the sum of the on-axis distance from the object-side surface of the first prism P1 to the reflective surface and the on-axis distance from the reflective surface to the image-side surface of the first prism P1;
dp1-01: the on-axis distance from the object-side surface of the first prism P1 to the reflective surface;
dp1-02: the on-axis distance from the reflective surface of the first prism P1 to the image-side surface;
dp2: the on-axis distance from the image-side surface of the first prism P1 to the object-side surface of the first lens L1;
d1: the on-axis thickness of the first lens L1;
d2: the on-axis distance from the image-side surface of the first lens L1 to the object-side surface of the second lens L2;
d3: the on-axis thickness of the second lens L2;
d4: the on-axis distance from the image-side surface of the second lens L2 to the object-side surface of the third lens L3;
d5: the on-axis thickness of the third lens L3;
d6: the on-axis distance from the image-side surface of the third lens L3 to the object-side surface of the fourth lens L4;
d7: the on-axis thickness of the fourth lens L4;
d8: the on-axis distance from the image-side surface of the fourth lens L4 to the object-side surface of the fifth lens L5;
d9: the on-axis thickness of the fifth lens L5;
d10: the on-axis distance from the image-side surface of the fifth lens L5 to the object-side surface of the optical filter GF;
d11: the on-axis thickness of the optical filter GF;
d12: the on-axis distance from the image-side surface of the optical filter GF to the imaging surface Si;
nd: the refractive index of d-line;
nd1: the refractive index of d-line of the first prism P1;
nd2: the refractive index of d-line of the first lens L1;
nd3: the refractive index of d-line of the second lens L2;
nd4: the refractive index of d-line of the third lens L3;
nd5: the refractive index of d-line of the fourth lens L4;
nd6: the refractive index of d-line of the fifth lens L5;
ndg: the refractive index of d-line of the optical filter GF;
vd: the Abbe number;
vd1: the Abbe number of the first prism P1;
vd2: the Abbe number of the first lens L1;
vd3: the Abbe number of the second lens L2;
vd4: the Abbe number of the third lens L3;
vd5: the Abbe number of the fourth lens L4;
vd6: the Abbe number of the fifth lens L5;
vdg: the Abbe number of the optical filter GF.

Table 3 lists the conic coefficients k and aspherical coefficients of the imaging optical lens 10 in the first embodiment of the present disclosure.

TABLE 3

Conic

| | |
|---|---|
| coefficient | Aspheric coefficient |

| | K | A4 | A6 | A8 | A10 | A12 |
|---|---|---|---|---|---|---|
| Rp1 | 2.65532E+01 | −1.20350E−04 | 2.56660E−06 | −8.18580E−07 | 1.09820E−07 | −9.54040E−09 |
| Rp2 | 0.00000E+00 | 0.00000E+00 | 0.00000E+00 | 0.00000E+00 | 0.00000E+00 | 0.00000E+00 |
| R1 | 1.70575E+01 | 7.34700E−04 | −1.52400E−04 | 7.66890E−05 | −2.76980E−05 | 6.80130E−06 |
| R2 | −1.99989E+01 | 9.67540E−04 | −5.06250E−05 | −3.74770E−05 | 1.44940E−05 | −2.71880E−06 |
| R3 | −2.41314E+01 | 8.59920E−03 | −2.68800E−03 | 5.31810E−04 | −7.32980E−05 | 6.92550E−06 |
| R4 | −2.83432E+00 | 4.72230E−04 | −5.99080E−05 | 5.66830E−05 | −1.54690E−05 | 2.06960E−06 |
| R5 | −1.35321E+01 | −1.79090E−02 | 6.50030E−03 | −1.21180E−03 | 1.47040E−04 | −1.19200E−05 |
| R6 | −9.42374E+01 | −3.78520E−03 | −5.47980E−06 | −3.28850E−05 | 8.49910E−06 | −7.84730E−07 |
| R7 | −2.61979E+01 | 6.44760E−03 | −3.18570E−03 | 4.45380E−04 | −3.42690E−05 | 1.73590E−06 |
| R8 | 1.39640E+01 | 2.16440E−03 | −6.63010E−04 | 9.05750E−05 | −5.55300E−06 | 1.36280E−07 |
| R9 | 5.73908E+00 | −1.68460E−04 | 1.99280E−05 | −9.68090E−06 | 2.06880E−06 | −2.52050E−07 |
| R10 | 3.23307E+00 | −3.96790E−04 | 1.66610E−04 | −9.12850E−05 | 2.76990E−05 | −5.44510E−06 |

| | Conic | | | | | |
|---|---|---|---|---|---|---|
| | coefficient | Aspheric coefficient | | | | |
| | K | A14 | A16 | A18 | A20 | A22 |
| Rp1 | 2.65532E+01 | 5.08290E−10 | −1.63250E−11 | 2.89480E−13 | −2.19430E−15 | 0.00000E+00 |
| Rp2 | 0.00000E+00 | 0.00000E+00 | 0.00000E+00 | 0.00000E+00 | 0.00000E+00 | 0.00000E+00 |
| R1 | 1.70575E+01 | −1.09730E−06 | 1.14620E−07 | −7.42750E−09 | 2.70710E−10 | −4.22490E−12 |
| R2 | −1.99989E+01 | 3.05610E−07 | −2.12450E−08 | 8.91650E−10 | −2.06810E−11 | 2.03420E−13 |
| R3 | −2.41314E+01 | −4.26630E−07 | 1.61680E−08 | −3.40570E−10 | 3.04670E−12 | 0.00000E+00 |
| R4 | −2.83432E+00 | −1.52580E−07 | 6.33520E−09 | −1.39300E−10 | 1.26700E−12 | 0.00000E+00 |
| R5 | −1.35321E+01 | 6.35980E−07 | −2.14190E−08 | 4.12410E−10 | −3.45370E−12 | 0.00000E+00 |
| R6 | −9.42374E+01 | 3.52080E−08 | −7.29160E−10 | 3.06290E−12 | 7.59100E−14 | 0.00000E+00 |
| R7 | −2.61979E+01 | −6.64590E−08 | 2.06170E−09 | −4.47500E−11 | 4.58920E−13 | 0.00000E+00 |
| R8 | 1.39640E+01 | 2.08300E−09 | −1.97890E−10 | 3.74930E−12 | −1.42670E−14 | 0.00000E+00 |
| R9 | 5.73908E+00 | 1.82350E−08 | −7.80600E−10 | 1.83140E−11 | −1.82000E−13 | 0.00000E+00 |
| R10 | 3.23307E+00 | 6.69800E−07 | −4.95930E−08 | 2.01270E−09 | −3.44240E−11 | 0.00000E+00 |

It should be noted that the aspherical surfaces of each lens in an embodiment are defined by the following relationship formula (24). However, the specific form of the following relationship formula (24) is only an example. The present disclosure is not limited to the aspherical polynomial form identified in relationship (24).

$$z = ( {c}^{2} / r ) / \{ 1 + {[ 1 - ( k + 1 ) ( {c}^{2} / {r}^{2} ) ]}^{1 / 2} \} + A 4 {c}^{4} + A 6 {c}^{6} + A 8 {c}^{8} + A 10 {c}^{10} + A 12 {c}^{12} + A 14 {c}^{14} + A 16 {c}^{16} + A 18 {c}^{18} + A 20 {c}^{20} + A 22 {c}^{22} \qquad ( 24 )$$

Herein, k is the conic coefficient; A4, A6, A8, A10, A12, A14, A16, A18, A20, A22 are aspherical coefficients; c is the curvature at the center of the optical surface; r is the vertical distance from a point on the aspherical curve to the optical axis; z is the aspherical depth (the vertical distance between a point on the aspherical surface at a distance r from the optical axis and the tangent plane at the vertex of the aspherical surface on the optical axis).

In addition, in the subsequent Table 25, the values corresponding to the parameters specified in the relationship formulas and various parameters in the first embodiment are also listed.

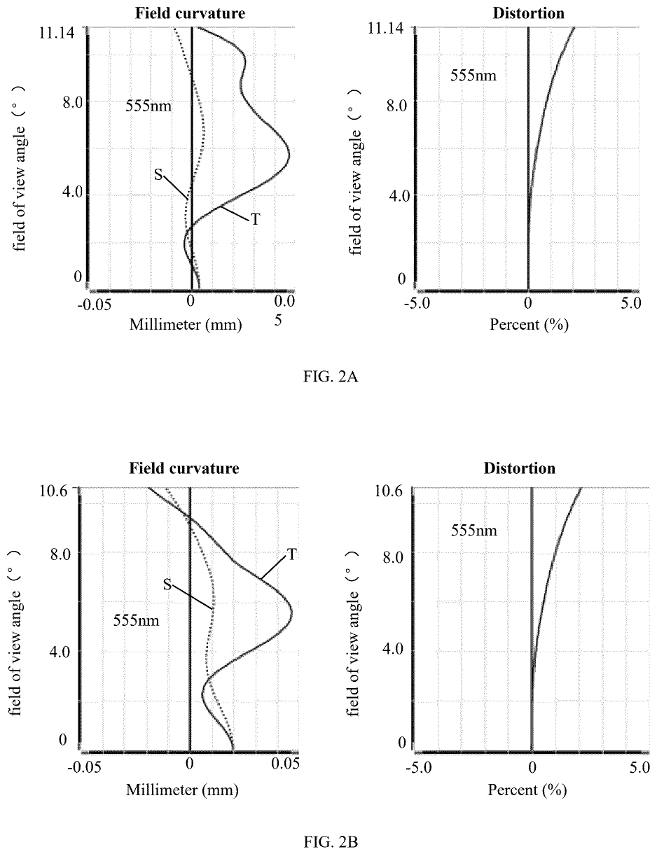

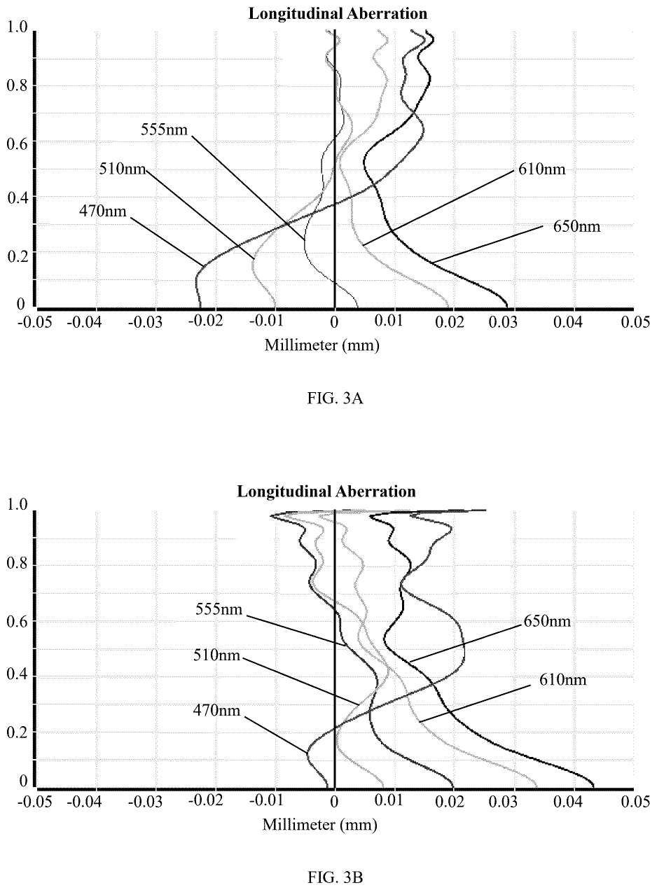

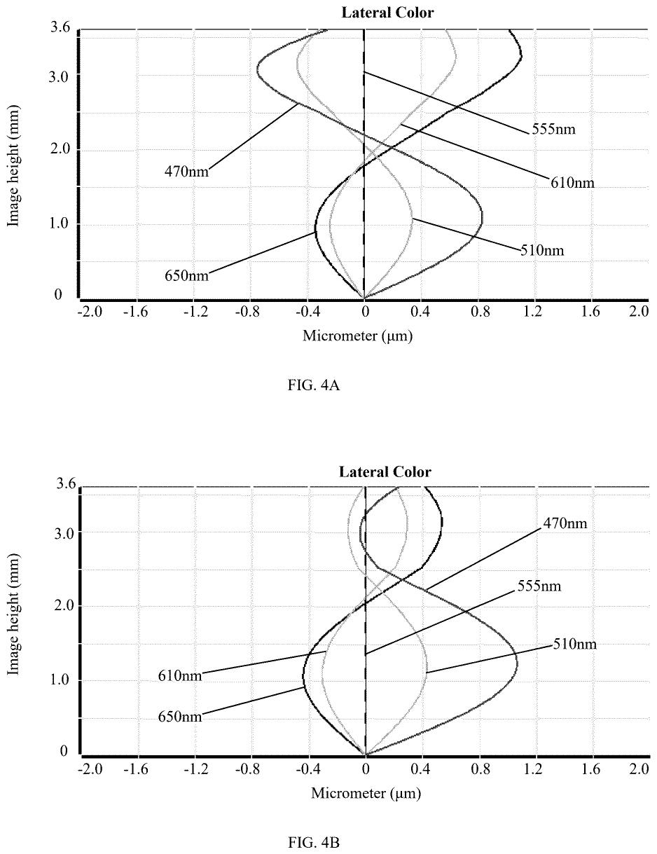

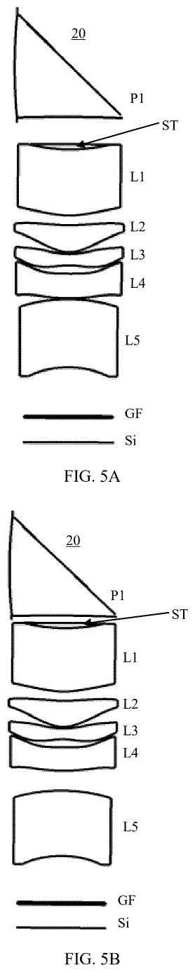

FIG. 2A and FIG. 2B show schematic diagrams of the field curvature and distortion of light with a wavelength of 555 nm after passing through the imaging optical lens 10 of the first embodiment. FIG. 3A and FIG. 3B show schematic diagrams of the longitudinal aberration of light with wavelengths of 470 nm, 510 nm, 555 nm, 610 nm, and 650 nm after passing through the imaging optical lens 10 of the first embodiment. FIG. 4A and FIG. 4B show schematic diagrams of the lateral color of light with wavelengths of 470 nm, 510 nm, 555 nm, 610 nm, and 650 nm after passing through the imaging optical lens 10 of the first embodiment.

As shown in Table 25, the first embodiment satisfies all the relationship formulas.

In an embodiment, the pupil entering diameter (ENPD) of the imaging optical lens 10 in the first state is 8.000 mm, the full-field image height is 3.600 mm, and the diagonal field of view is 22.29°. The imaging optical lens 10 has the characteristics of a large aperture, telephoto, and miniaturization, with its on-axis and off-axis chromatic aberrations fully corrected, and excellent optical performance.

### Second Embodiment

The first prism P1, has positive refractive power, with its object-side surface being convex in the paraxial region and its image-side surface being concave in the paraxial region;
the first lens L1, has positive refractive power, with its object-side surface being concave in the paraxial region and its image-side surface being convex in the paraxial region;
the second lens L2, has positive refractive power, with its object-side surface being concave in the paraxial region and its image-side surface being convex in the paraxial region;
the third lens L3, has negative refractive power, with its object-side surface being concave in the paraxial region and its image-side surface being concave in the paraxial region;
the fourth lens L4, has positive refractive power, with its object-side surface being concave in the paraxial region and its image-side surface being convex in the paraxial region; and
the fifth lens L5, has negative refractive power, with its object-side surface being convex in the paraxial region and its image-side surface being concave in the paraxial region.

FIG. 5A and FIG. 5B are schematic structural diagrams of the imaging optical lens 20 in the second embodiment. The second embodiment is basically the same as the first embodiment, with the same symbol meanings as the first embodiment, and only the differences are listed below.

Tables 4-6 show the design data of the imaging optical lens 20 in the second embodiment of the present disclosure.

TABLE 4

| | R | d | | nd | | vd | |
|---|---|---|---|---|---|---|---|
| ST | ∞ | d0= | d0 | | | | |
| Rp1 | 48.591 | dp1= | 9.800 | nd1 | 1.8052 | vd1 | 40.91 |
| Rp2 | 133.493 | dp2= | dp2 | | | | |
| R1 | −14.458 | d1= | 6.135 | nd2 | 1.6400 | vd2 | 23.54 |
| R2 | −6.571 | d2= | 0.900 | | | | |
| R3 | −9.831 | d3= | 2.511 | nd3 | 1.5444 | vd3 | 55.82 |
| R4 | −2.621 | d4= | 0.150 | | | | |
| R5 | −7.892 | d5= | 1.046 | nd4 | 1.6153 | vd4 | 25.94 |
| R6 | 4.925 | d6= | 0.785 | | | | |
| R7 | −27.471 | d7= | 2.276 | nd5 | 1.6700 | vd5 | 19.39 |
| R8 | −14.398 | d8= | d8 | | | | |
| R9 | 15.056 | d9= | 6.321 | nd6 | 1.5346 | vd6 | 55.69 |
| R10 | 9.219 | d10= | 4.484 | | | | |
| R11 | ∞ | d11= | 0.210 | ndg | 1.5168 | vdg | 64.17 |
| R12 | ∞ | d12= | 2.259 | | | | |

Herein, dp1=“dp1-01”+“dp1-02”, “dp1-01”=5.0, “dp1-02”=4.8.

Table 5 lists relevant optical parameters of the imaging optical lens 20 in the second embodiment of the present disclosure in the first state and the second state respectively.

TABLE 5

| | In the first state | In the second state |
|---|---|---|
| f | 17.787 | 17.050 |
| FOV | 22.42° | 21.40° |
| FNO | 2.22 | 2.32 |
| d0 | −12.343 | −10.542 |
| dp2 | 3.023 | 1.222 |
| d8 | 0.100 | 1.901 |

Table 6 lists the conic coefficients k and aspherical coefficients of the imaging optical lens 20 in the second embodiment of the present disclosure.

TABLE 6

| | Conic coefficient | Aspheric coefficient | | | | |
|---|---|---|---|---|---|---|
| | K | A4 | A6 | A8 | A10 | A12 |
| Rp1 | 3.70188E+01 | −5.79990E−05 | 1.83900E−10 | 1.40200E−07 | −1.98160E−08 | 1.25880E−09 |
| Rp2 | 0.00000E+00 | 0.00000E+00 | 0.00000E+00 | 0.00000E+00 | 0.00000E+00 | 0.00000E+00 |
| R1 | 1.13339E+01 | 8.32300E−04 | −1.01060E−04 | 4.53850E−05 | −1.53510E−05 | 3.52390E−06 |
| R2 | −1.61257E+01 | 3.63560E−04 | 9.75250E−05 | −5.10660E−05 | 1.08840E−05 | −1.48170E−06 |
| R3 | −4.25342E+01 | 6.55430E−03 | −1.61290E−03 | 2.69100E−04 | −3.41770E−05 | 3.12160E−06 |
| R4 | −3.40948E+00 | 1.26160E−03 | −3.54230E−04 | 9.26120E−05 | −1.61110E−05 | 1.75520E−06 |
| R5 | −1.37437E+01 | −1.33350E−02 | 4.45960E−03 | −7.62860E−04 | 8.60680E−05 | −6.56930E−06 |
| R6 | −1.63781E+01 | −9.86960E−03 | 1.09830E−03 | −1.26800E−04 | 1.06700E−05 | −5.90030E−07 |
| R7 | −2.54651E+01 | 3.59760E−03 | −2.73850E−03 | 4.77530E−04 | −4.85770E−05 | 3.33320E−06 |
| R8 | 6.73205E+00 | 2.16850E−03 | −4.90320E−04 | 6.91270E−05 | −3.61160E−06 | −2.14860E−08 |
| R9 | 5.01802E+00 | −1.33740E−04 | 3.70700E−05 | −1.62860E−05 | 3.48850E−06 | −4.34570E−07 |
| R10 | 2.74470E+00 | −1.54490E−04 | 1.44380E−04 | −5.74130E−05 | 1.44290E−05 | −2.57110E−06 |
| | Conic coefficient | Aspheric coefficient | | | | |
| | K | A14 | A16 | A18 | A20 | A22 |
| Rp1 | 3.70188E+01 | −4.38970E−11 | 7.89630E−13 | −5.01010E−15 | −1.92320E−17 | 0.00000E+00 |
| Rp2 | 0.00000E+00 | 0.00000E+00 | 0.00000E+00 | 0.00000E+00 | 0.00000E+00 | 0.00000E+00 |
| R1 | 1.13339E+01 | −5.24920E−07 | 5.03000E−08 | −2.98080E−09 | 9.92150E−11 | −1.41400E−12 |
| R2 | −1.61257E+01 | 1.36240E−07 | −8.24900E−09 | 3.11120E−10 | −6.58220E−12 | 5.94680E−14 |
| R3 | −4.25342E+01 | −1.87350E−07 | 6.87590E−09 | −1.39200E−10 | 1.18900E−12 | 0.00000E+00 |
| R4 | −3.40948E+00 | −1.15300E−07 | 4.43000E−09 | −9.17460E−11 | 7.91950E−13 | 0.00000E+00 |
| R5 | −1.37437E+01 | 3.32070E−07 | −1.05990E−08 | 1.92950E−10 | −1.52350E−12 | 0.00000E+00 |
| R6 | −1.63781E+01 | 2.14870E−08 | −5.15130E−10 | 7.64880E−12 | −5.32310E−14 | 0.00000E+00 |
| R7 | −2.54651E+01 | −1.56920E−07 | 4.85480E−09 | −8.83990E−11 | 7.14280E−13 | 0.00000E+00 |
| R8 | 6.73205E+00 | 1.22110E−08 | −6.22030E−10 | 1.35930E−11 | −1.08690E−13 | 0.00000E+00 |
| R9 | 5.01802E+00 | 3.25220E−08 | −1.44640E−09 | 3.52880E−11 | −3.64320E−13 | 0.00000E+00 |
| R10 | 2.74470E+00 | 3.08550E−07 | −2.31370E−08 | 9.66350E−10 | −1.70900E−11 | 0.00000E+00 |

In addition, in the subsequent Table 25, the values corresponding to the parameters specified in the relationship formulas in the second embodiment are also listed.

FIG. 6A and FIG. 6B show schematic diagrams of the field curvature and distortion of light with a wavelength of 555 nm after passing through the imaging optical lens 20 of the second embodiment. FIG. 7A and FIG. 7B show schematic diagrams of the longitudinal aberration of light with wavelengths of 470 nm, 510 nm, 555 nm, 610 nm, and 650 nm after passing through the imaging optical lens 20 of the second embodiment. FIG. 8A and FIG. 8B show schematic diagrams of the lateral color of light with wavelengths of 470 nm, 510 nm, 555 nm, 610 nm, and 650 nm after passing through the imaging optical lens 10 of the second embodiment.

As shown in Table 25, the second embodiment satisfies all the relationship formulas.

In an embodiment, the entrance pupil diameter of the imaging optical lens 20 in the first state is 8.000 mm, the full-field image height is 3.600 mm, and the diagonal field of view is 22.42°. The imaging optical lens 20 has the characteristics of a large aperture, long focal length, and miniaturization. Its on-axis and off-axis chromatic aberrations are fully corrected, and it has excellent optical performance.

### Third Embodiment

The first prism P1, has positive refractive power, with its object-side surface being convex in the paraxial region and its image-side surface being concave in the paraxial region;
the first lens L1, has positive refractive power, with its object-side surface being concave in the paraxial region and its image-side surface being convex in the paraxial region;
the second lens L2, has positive refractive power, with its object-side surface being concave in the paraxial region and its image-side surface being convex in the paraxial region;
the third lens L3, has negative refractive power, with its object-side surface being concave in the paraxial region and its image-side surface being concave in the paraxial region;
the fourth lens L4, has positive refractive power, with its object-side surface being concave in the paraxial region and its image-side surface being convex in the paraxial region; and
the fifth lens L5, has positive refractive power, with its object-side surface being concave in the paraxial region and its image-side surface being convex in the paraxial region.

FIG. 9A and FIG. 9B are schematic structural diagrams of the imaging optical lens 30 in the third embodiment. The third embodiment is substantially the same as the first embodiment, with the same symbol meanings as the first embodiment, and only differences are listed below.

Tables 7-9 show the design data of the imaging optical lens 30 in the third embodiment of the present disclosure.

TABLE 7

| | R | d | | nd | | vd | |
|---|---|---|---|---|---|---|---|
| ST | ∞ | d0= | d0 | | | | |
| Rp1 | 119.049 | dp1= | 9.800 | nd1 | 1.8052 | vd1 | 40.91 |
| Rp2 | 169.347 | dp2= | dp2 | | | | |
| R1 | −13.490 | d1= | 5.186 | nd2 | 1.6400 | vd2 | 23.54 |
| R2 | −4.469 | d2= | 0.900 | | | | |
| R3 | −11.673 | d3= | 2.470 | nd3 | 1.5444 | vd3 | 55.82 |
| R4 | −1.952 | d4= | 0.150 | | | | |
| R5 | −2.106 | d5= | 0.900 | nd4 | 1.6153 | vd4 | 25.94 |
| R6 | 8.991 | d6= | 1.080 | | | | |
| R7 | −43.879 | d7= | 1.651 | nd5 | 1.6700 | vd5 | 19.39 |
| R8 | −10.668 | d8= | d8 | | | | |
| R9 | −37.626 | d9= | 0.800 | nd6 | 1.5346 | vd6 | 55.69 |
| R10 | −28.524 | d10= | 7.927 | | | | |
| R11 | ∞ | d11= | 0.210 | ndg | 1.5168 | vdg | 64.17 |
| R12 | ∞ | d12= | 5.703 | | | | |

Herein, dp1=“dp1-01”+“dp1-02”, “dp1-01”=5.0, “dp1-02”=4.8.

Table 8 lists relevant optical parameters of the imaging optical lens 30 in the third embodiment in the first state and the second state respectively.

TABLE 8

| | In the first state | In the second state |
|---|---|---|
| f | 18.268 | 18.346 |
| FOV | 22.20° | 20.69° |
| FNO | 2.28 | 2.44 |
| d0 | −12.459 | −10.525 |
| dp2 | 3.123 | 1.189 |
| d8 | 0.100 | 2.034 |

Table 9 lists the conic coefficients and aspherical coefficients of the imaging optical lens 30 in the third embodiment of the present disclosure.

TABLE 9

| | Conic coefficient | Aspheric coefficient | | | | |
|---|---|---|---|---|---|---|
| | K | A4 | A6 | A8 | A10 | A12 |
| Rp1 | 6.41440E+01 | −3.80840E−05 | −2.98450E−06 | 1.12420E−06 | −1.61720E−07 | 1.32350E−08 |
| Rp2 | 0.00000E+00 | 0.00000E+00 | 0.00000E+00 | 0.00000E+00 | 0.00000E+00 | 0.00000E+00 |
| R1 | 6.42713E+00 | 1.38530E−03 | −7.59450E−05 | 1.35720E−05 | −4.16110E−06 | 1.02260E−06 |
| R2 | −7.75251E+00 | 1.58760E−03 | −2.16550E−04 | −1.02050E−05 | 8.88780E−06 | −1.45730E−06 |
| R3 | −8.74767E+01 | 1.03380E−02 | −2.61990E−03 | 3.54820E−04 | −3.09380E−05 | 1.92030E−06 |
| R4 | −5.56199E+00 | −3.71680E−03 | 5.05320E−04 | −1.60290E−05 | −4.08890E−06 | 7.57650E−07 |
| R5 | −6.76939E+00 | −3.63240E−03 | 2.27010E−03 | −4.25900E−04 | 4.99240E−05 | −3.82390E−06 |
| R6 | −1.30930E+01 | −3.40820E−03 | 5.59800E−04 | −1.83730E−04 | 2.69540E−05 | −2.27820E−06 |
| R7 | 2.27494E+01 | −6.62450E−03 | −4.53670E−04 | 7.95240E−05 | 3.90730E−06 | −1.32060E−06 |
| R8 | 3.36020E+00 | −6.44930E−04 | −3.74500E−04 | 1.00210E−04 | −1.03270E−05 | 8.72040E−07 |
| R9 | 6.50480E+01 | 7.71090E−04 | 1.33730E−05 | −6.00420E−06 | 1.25140E−06 | −1.34140E−07 |
| R10 | 3.83960E+01 | 8.27680E−04 | 4.38390E−05 | −1.13230E−05 | 1.52620E−06 | −8.54830E−08 |
| | Conic coefficient | Aspheric coefficient | | | | |
| | K | A14 | A16 | A18 | A20 | A22 |
| Rp1 | 6.41440E+01 | −6.56250E−10 | 1.94470E−11 | −3.16490E−13 | 2.17440E−15 | 0.00000E+00 |
| Rp2 | 0.00000E+00 | 0.00000E+00 | 0.00000E+00 | 0.00000E+00 | 0.00000E+00 | 0.00000E+00 |
| R1 | 6.42713E+00 | −1.51520E−07 | 1.35630E−08 | −7.22510E−10 | 2.11210E−11 | −2.61010E−13 |
| R2 | −7.75251E+00 | 1.29570E−07 | −7.03000E−09 | 2.31600E−10 | −4.24670E−12 | 3.31480E−14 |
| R3 | −8.74767E+01 | −8.34250E−08 | 2.34750E−09 | −3.79470E−11 | 2.67800E−13 | 0.00000E+00 |
| R4 | −5.56199E+00 | −5.57500E−08 | 2.07470E−09 | −3.88590E−11 | 2.93550E−13 | 0.00000E+00 |
| R5 | −6.76939E+00 | 1.90380E−07 | −5.96090E−09 | 1.06690E−10 | −8.30000E−13 | 0.00000E+00 |
| R6 | −1.30930E+01 | 1.19250E−07 | −3.78450E−09 | 6.62230E−11 | −4.85970E−13 | 0.00000E+00 |
| R7 | 2.27494E+01 | 1.06590E−07 | −4.23670E−09 | 8.52630E−11 | −6.91700E−13 | 0.00000E+00 |
| R8 | 3.36020E+00 | −6.21120E−08 | 3.06520E−09 | −8.69370E−11 | 1.05180E−12 | 0.00000E+00 |
| R9 | 6.50480E+01 | 9.19980E−09 | −3.91360E−10 | 9.17040E−12 | −8.42760E−14 | 0.00000E+00 |
| R10 | 3.83960E+01 | 6.31800E−10 | 1.79580E−10 | −9.11060E−12 | 1.52830E−13 | 0.00000E+00 |

In addition, in the subsequent Table 25, the values corresponding to the parameters specified in the relationship formulas and various parameters in the third embodiment are also listed.

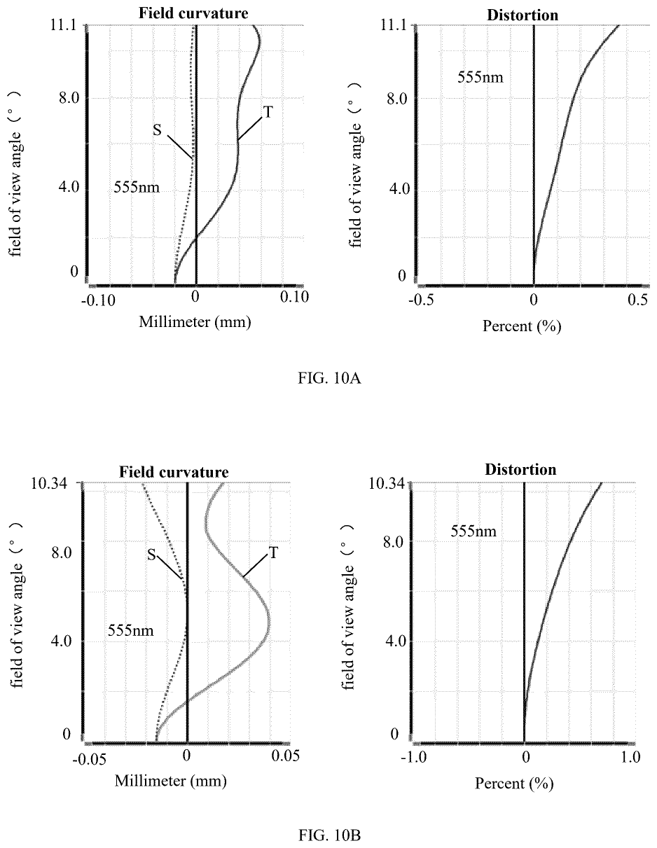

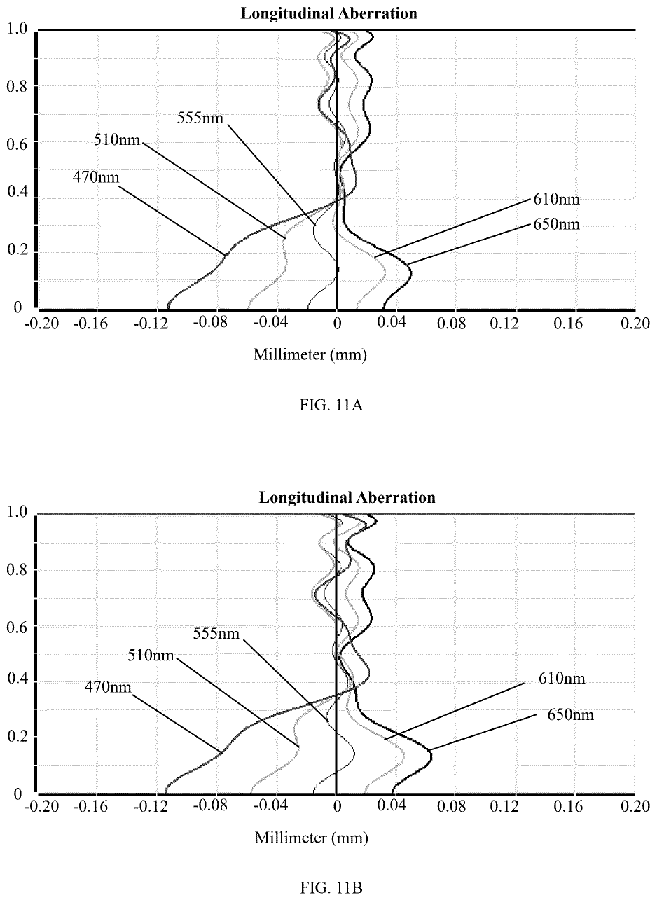

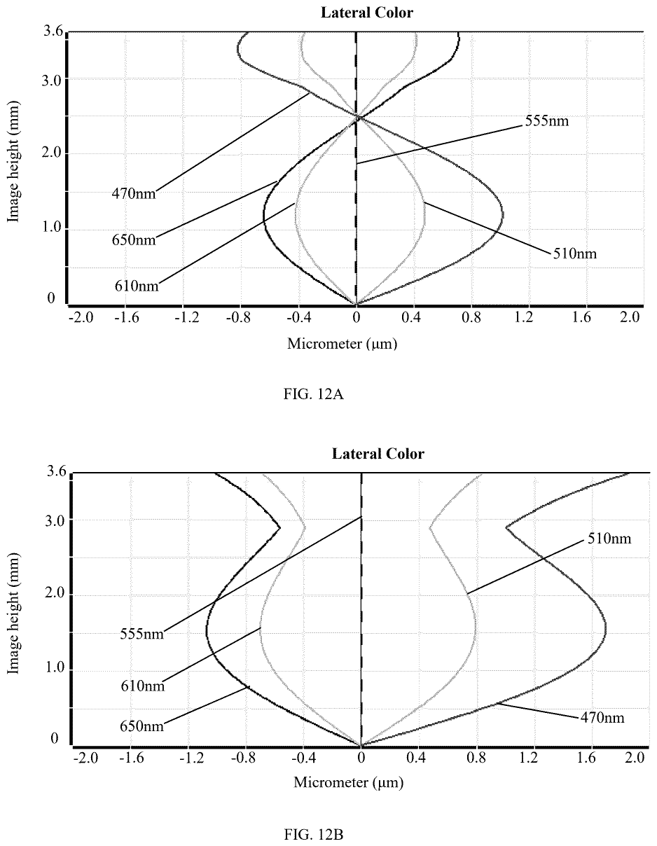

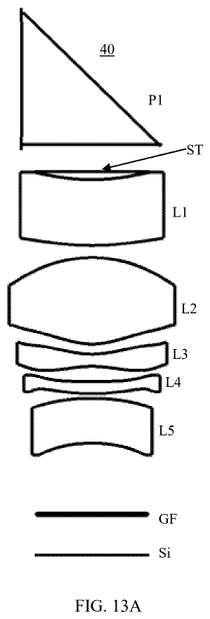

FIG. 10A and FIG. 10B show schematic diagrams of the field curvature and distortion of light with of 555 nm after passing through the imaging optical lens 30 of the third embodiment. FIG. 11A and FIG. 11B show schematic diagrams of the longitudinal aberration of light with wavelengths of 470 nm, 510 nm, 555 nm, 610 nm, and 650 nm after passing through the imaging optical lens 30 of the third embodiment. FIG. 12A and FIG. 12B show schematic diagrams of the lateral color of light with wavelengths of 470 nm, 510 nm, 555 nm, 610 nm, and 650 nm after passing through the imaging optical lens 30 of the third embodiment.

As shown in Table 25, the third embodiment satisfies all the relationship formulas.

In an embodiment, the entrance pupil diameter of the imaging optical lens 30 in the first state is 8.000 mm, the full-field image height is 3.600 mm, and the diagonal field of view is 22.20°. The imaging optical lens 30 has the characteristics of a large aperture, long focal length, and miniaturization, with its on-axis and off-axis chromatic aberrations are fully corrected, and excellent optical performance.

### Fourth Embodiment

The first prism P1, has negative refractive power, with its object-side surface being concave in the paraxial region and its image-side surface being planar in the paraxial region;
the first lens L1, has negative refractive power, with its object-side surface being concave in the paraxial region and its image-side surface being convex in the paraxial region;
the second lens L2, has positive refractive power, with its object-side surface being convex in the paraxial region and its image-side surface being convex in the paraxial region;
the third lens, L3, has negative refractive power, with its object-side surface being concave in the paraxial region and its image-side surface also being concave in the paraxial region;
the fourth lens L4, has positive refractive power, with its object-side surface being convex in the paraxial region and its image-side surface being convex in the paraxial region; and
the fifth lens L5, has negative refractive power, with its object-side surface being convex in the paraxial region and its image-side surface being concave in the paraxial region.

FIG. 13A and FIG. 13B are schematic diagrams showing the structure of the imaging optical lens 40 in the fourth embodiment. The fourth embodiment is basically the same as the first embodiment, and the meanings of the symbols are the same as those in the first embodiment. Only the differences are listed below.

Tables 10-12 show the design data of the imaging optical lens 40 according to the fourth embodiment of the present invention.

TABLE 10

| | R | d | | nd | | vd | |
|---|---|---|---|---|---|---|---|
| ST | ∞ | d0= | d0 | | | | |
| Rp1 | −373.105 | dp1= | 9.800 | nd1 | 1.8052 | vd1 | 40.91 |
| Rp2 | ∞ | dp2= | dp2 | | | | |
| R1 | −14.287 | d1= | 4.840 | nd2 | 1.6400 | vd2 | 23.54 |
| R2 | −20.036 | d2= | 0.900 | | | | |
| R3 | 8.634 | d3= | 6.352 | nd3 | 1.5444 | vd3 | 55.82 |
| R4 | −4.640 | d4= | 0.749 | | | | |
| R5 | −5.719 | d5= | 0.900 | nd4 | 1.6153 | vd4 | 25.94 |
| R6 | 7.141 | d6= | 1.101 | | | | |
| R7 | 51.053 | d7= | 0.900 | nd5 | 1.6700 | vd5 | 19.39 |
| R8 | −15.427 | d8= | d8 | | | | |
| R9 | 15.072 | d9= | 3.297 | nd6 | 1.5346 | vd6 | 55.69 |
| R10 | 10.349 | d10= | 5.120 | | | | |
| R11 | ∞ | d11= | 0.210 | ndg | 1.5168 | vdg | 64.17 |
| R12 | ∞ | d12= | 2.895 | | | | |

Herein, dp1=“dp1-01”+“dp1-02”, “dp1-01”=5.0, “dp1-02”=4.8.

Table 11 lists relevant optical parameters of the imaging optical lens 40 in the fourth embodiment of the present disclosure in the first state and the second state respectively.

TABLE 11

| | In the first state | In the second state |
|---|---|---|
| f | 16.626 | 16.397 |
| FOV | 23.91° | 22.51° |
| FNO | 2.08 | 2.20 |
| d0 | −11.818 | −10.459 |
| dp2 | 2.590 | 1.231 |
| d8 | 0.346 | 1.705 |

Table 12 lists the conic coefficients k and aspherical coefficients of the imaging optical lens 40 in the fourth embodiment of the present disclosure.

TABLE 12

| | Conic coefficient | Aspheric coefficient | | | | |
|---|---|---|---|---|---|---|
| | K | A4 | A6 | A8 | A10 | A12 |
| Rp1 | −4.54098E+01 | −2.68900E−05 | 3.75270E−06 | −7.34770E−07 | 7.91190E−08 | −5.10480E−09 |
| Rp2 | 0.00000E+00 | 0.00000E+00 | 0.00000E+00 | 0.00000E+00 | 0.00000E+00 | 0.00000E+00 |
| R1 | 7.50384E+00 | 3.27140E−04 | 1.22470E−04 | −3.71100E−05 | 8.72340E−06 | −1.37590E−06 |
| R2 | 3.74086E+00 | −6.52690E−04 | 2.12030E−04 | −3.09300E−05 | 3.43220E−06 | −2.82070E−07 |
| R3 | −1.82029E+01 | 2.34790E−03 | −1.29990E−04 | 9.00170E−06 | −6.21810E−07 | 3.39400E−08 |
| R4 | −6.21781E+00 | 1.83720E−03 | −2.19750E−04 | 1.90670E−05 | −1.40450E−06 | 9.95530E−08 |
| R5 | −1.00884E+01 | 1.39850E−03 | 1.53080E−04 | −9.24840E−05 | 1.50310E−05 | −1.25440E−06 |
| R6 | −8.10399E+00 | −7.24270E−03 | 1.82820E−03 | −3.32670E−04 | 3.51040E−05 | −2.19400E−06 |
| R7 | 9.48789E+01 | −6.69690E−03 | 7.23990E−04 | 6.73420E−05 | −3.67470E−05 | 5.14590E−06 |
| R8 | 4.11417E+00 | −1.51950E−03 | 2.76000E−04 | 4.98300E−05 | −1.81000E−05 | 2.22250E−06 |
| R9 | −5.45192E+01 | 2.29010E−03 | −2.41070E−04 | 3.30290E−05 | −3.58000E−06 | 2.44170E−07 |
| R10 | −2.73269E+01 | 3.74930E−03 | −2.85000E−04 | 5.61500E−06 | 8.35620E−06 | −2.18110E−06 |
| | Conic coefficient | Aspheric coefficient | | | | |
| | K | A14 | A16 | A18 | A20 | A22 |
| Rp1 | −4.54098E+01 | 1.99760E−10 | −4.54100E−12 | 5.30690E−14 | −2.26540E−16 | 0.00000E+00 |
| Rp2 | 0.00000E+00 | 0.00000E+00 | 0.00000E+00 | 0.00000E+00 | 0.00000E+00 | 0.00000E+00 |
| R1 | 7.50384E+00 | 1.44680E−07 | −9.97970E−09 | 4.33520E−10 | −1.07510E−11 | 1.16070E−13 |
| R2 | 3.74086E+00 | 1.64740E−08 | −6.56660E−10 | 1.68380E−11 | −2.48890E−13 | 1.60520E−15 |
| R3 | −1.82029E+01 | −1.26540E−09 | 2.95230E−11 | −3.90750E−13 | 2.25210E−15 | 0.00000E+00 |
| R4 | −6.21781E+00 | −5.11840E−09 | 1.56480E−10 | −2.54520E−12 | 1.71300E−14 | 0.00000E+00 |
| R5 | −1.00884E+01 | 6.16060E−08 | −1.81560E−09 | 2.97590E−11 | −2.07920E−13 | 0.00000E+00 |
| R6 | −8.10399E+00 | 8.03570E−08 | −1.61220E−09 | 1.44510E−11 | −2.11760E−14 | 0.00000E+00 |
| R7 | 9.48789E+01 | −3.66810E−07 | 1.45610E−08 | −3.06720E−10 | 2.67740E−12 | 0.00000E+00 |
| R8 | 4.11417E+00 | −1.40800E−07 | 4.97240E−09 | −9.41220E−11 | 7.72720E−13 | 0.00000E+00 |
| R9 | −5.45192E+01 | −7.67250E−09 | −8.80370E−11 | 1.29360E−11 | −2.54400E−13 | 0.00000E+00 |
| R10 | −2.73269E+01 | 2.84050E−07 | −2.11260E−08 | 8.50020E−10 | −1.43430E−11 | 0.00000E+00 |

In addition, in the subsequent Table 25, the values corresponding to the parameters specified in the relationship formulas and various parameters in the fourth embodiment are also listed.

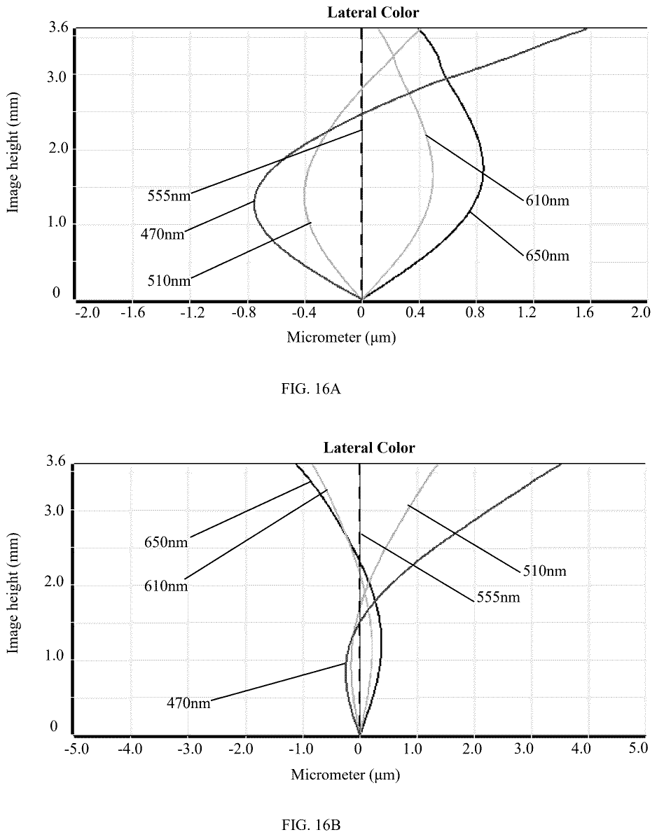

FIG. 14A and FIG. 14B show schematic diagrams of the field curvature and distortion of light with of 555 nm after passing through the imaging optical lens 40 of the fourth embodiment. FIG. 15A and FIG. 15B show schematic diagrams of the longitudinal aberration of light with wavelengths of 470 nm, 510 nm, 555 nm, 610 nm, and 650 nm after passing through the imaging optical lens 40 of the fourth embodiment. FIG. 16A and FIG. 16B show schematic diagrams of the lateral color of light with wavelengths of 470 nm, 510 nm, 555 nm, 610 nm, and 650 nm after passing through the imaging optical lens 40 of the fourth embodiment.

As shown in Table 25, the fourth embodiment satisfies all the relationship formulas.

In an embodiment, the entrance pupil diameter of the imaging optical lens 40 in the first state is 8.000 mm, the full-field image height is 3.600 mm, and the diagonal field of view is 23.91°. The imaging optical lens 40 has the characteristics of a large aperture, long focal length, and miniaturization, with its on-axis and off-axis chromatic aberrations are fully corrected, and excellent optical performance.

### Fifth Embodiment

The first prism P1, has positive refractive power, with its object-side surface being convex in the paraxial region and its image-side surface being convex in the paraxial region;
the first lens L1, has negative refractive power, with its object-side surface being concave in the paraxial region and its image-side surface being convex in the paraxial region;
the second lens L2, has positive refractive power, with its object-side surface being convex in the paraxial region and its image-side surface being convex in the paraxial region;
the third lens L3, has negative refractive power, with its object-side surface being concave in the paraxial region and its image-side surface also being concave in the paraxial region;
the fourth lens L4, has positive refractive power, with its object-side surface being convex in the paraxial region and its image-side surface being convex in the paraxial region; and
the fifth lens L5, has negative refractive power, with its object-side surface being convex in the paraxial region and its image-side surface being concave in the paraxial region.

FIG. 17A and FIG. 17B are schematic diagrams showing the structure of the imaging optical lens 50 in the fifth embodiment. The fifth embodiment is basically the same as the first embodiment, and the meanings of the symbols are the same as those in the first embodiment. Only the differences are listed below.

Tables 13-15 show the design data of the imaging optical lens 50 according to the fifth embodiment of the present invention.

TABLE 13

| | R | d | | nd | | vd | |
|---|---|---|---|---|---|---|---|
| ST | ∞ | d0= | d0 | | | | |
| Rp1 | 65.150 | dp1= | 9.800 | nd1 | 1.8052 | vd1 | 40.91 |
| Rp2 | −108.584 | dp2= | dp2 | | | | |
| R1 | −13.813 | d1= | 5.076 | nd2 | 1.6400 | vd2 | 23.54 |
| R2 | −20.604 | d2= | 0.900 | | | | |
| R3 | 8.791 | d3= | 5.403 | nd3 | 1.5444 | vd3 | 55.82 |
| R4 | −4.955 | d4= | 0.876 | | | | |
| R5 | −8.105 | d5= | 0.900 | nd4 | 1.6153 | vd4 | 25.94 |
| R6 | 5.692 | d6= | 1.261 | | | | |
| R7 | 49.188 | d7= | 0.900 | nd5 | 1.6700 | vd5 | 19.39 |
| R8 | −16.991 | d8= | d8 | | | | |
| R9 | 17.887 | d9= | 3.089 | nd6 | 1.5346 | vd6 | 55.69 |
| R10 | 11.969 | d10= | 5.428 | | | | |
| R11 | ∞ | d11= | 0.210 | ndg | 1.5168 | vdg | 64.17 |
| R12 | ∞ | d12= | 3.203 | | | | |

Herein, dp1=“dp1-01”+“dp1-02”, “dp1-01”=5.0, “dp1-02”=4.8.

Table 14 lists relevant optical parameters of the imaging optical lens 50 in the fifth embodiment of the present disclosure in the first state and the second state respectively.

TABLE 14

| | In the first state | In the second state |
|---|---|---|
| f | 17.257 | 16.949 |
| FOV | 23.08° | 21.77° |
| FNO | 2.16 | 2.28 |
| d0 | −11.852 | −10.457 |
| dp2 | 2.635 | 1.241 |
| d8 | 0.319 | 1.714 |

Table 15 lists the conic coefficients k and aspherical coefficients of the imaging optical lens 50 in the fifth embodiment of the present disclosure.

TABLE 15

| | Conic coefficient | Aspheric coefficient | | | | |
|---|---|---|---|---|---|---|
| | K | A4 | A6 | A8 | A10 | A12 |
| Rp | −9.89236E+01 | −1.98570E−05 | 3.20540E−06 | −7.34800E−07 | 8.80290E−08 | −6.41850E−09 |
| Rp2 | 0.00000E+00 | 0.00000E+00 | 0.00000E+00 | 0.00000E+00 | 0.00000E+00 | 0.00000E+00 |
| R1 | 7.39006E+00 | 2.98200E−04 | 1.14000E−04 | −2.88990E−05 | 6.29440E−06 | −9.46260E−07 |
| R2 | 3.74761E+00 | −8.62690E−04 | 2.55780E−04 | −3.58530E−05 | 3.82530E−06 | −3.07230E−07 |
| R3 | −1.94402E+01 | 2.18380E−03 | −9.17840E−05 | 5.41510E−06 | −4.19330E−07 | 2.62220E−08 |
| R4 | −6.22689E+00 | 1.90440E−03 | −2.25020E−04 | 2.19620E−05 | −2.02260E−06 | 1.57710E−07 |
| R5 | −1.04300E+01 | 1.29070E−03 | 3.68230E−04 | −1.43100E−04 | 2.07980E−05 | −1.62880E−06 |
| R6 | −6.76681E+00 | −8.44350E−03 | 2.42070E−03 | −4.62260E−04 | 5.17750E−05 | −3.51200E−06 |
| R7 | 9.31948E+01 | −6.72590E−03 | 1.04480E−03 | −2.05570E−07 | −2.91410E−05 | 4.62180E−06 |
| R8 | 3.61030E+00 | −2.01830E−03 | 5.56880E−04 | −4.68330E−06 | −1.20500E−05 | 1.76700E−06 |
| R9 | −6.17579E+01 | 1.72070E−03 | −1.65750E−04 | 2.88640E−05 | −4.56910E−06 | 5.17440E−07 |
| R10 | −4.61580E+01 | 4.18780E−03 | −5.62200E−04 | 1.03490E−04 | −1.59410E−05 | 1.87320E−06 |
| | Conic coefficient | Aspheric coefficient | | | | |
| | K | A14 | A16 | A18 | A20 | A22 |
| Rp1 | −9.89236E+01 | 2.93860E−10 | −8.24190E−12 | 1.29420E−13 | −8.72560E−16 | 0.00000E+00 |
| Rp2 | 0.00000E+00 | 0.00000E+00 | 0.00000E+00 | 0.00000E+00 | 0.00000E+00 | 0.00000E+00 |
| R1 | 7.39006E+00 | 9.62860E−08 | −6.47910E−09 | 2.76290E−10 | −6.76050E−12 | 7.24220E−14 |
| R2 | 3.74761E+00 | 1.78620E−08 | −7.19630E−10 | 1.88690E−11 | −2.87730E−13 | 1.92830E−15 |
| R3 | −1.94402E+01 | −1.03570E−09 | 2.40310E−11 | −3.06870E−13 | 1.72190E−15 | 0.00000E+00 |
| R4 | −6.22689E+00 | −8.10890E−09 | 2.44820E−10 | −3.95150E−12 | 2.64840E−14 | 0.00000E+00 |
| R5 | −1.04300E+01 | 7.57320E−08 | −2.10970E−09 | 3.26510E−11 | −2.15960E−13 | 0.00000E+00 |
| R6 | −6.76681E+00 | 1.45450E−07 | −3.58360E−09 | 4.80310E−11 | −2.67410E−13 | 0.00000E+00 |
| R7 | 9.31948E+01 | −3.43630E−07 | 1.38820E−08 | −2.94240E−10 | 2.56990E−12 | 0.00000E+00 |
| R8 | 3.61030E+00 | −1.15250E−07 | 3.91960E−09 | −6.72030E−11 | 4.75570E−13 | 0.00000E+00 |
| R9 | −6.17579E+01 | −3.85120E−08 | 1.77970E−09 | −4.63530E−11 | 5.20830E−13 | 0.00000E+00 |
| R10 | −4.61580E+01 | −1.56680E−07 | 8.63660E−09 | −2.79500E−10 | 4.01550E−12 | 0.00000E+00 |

In addition, in the subsequent Table 25, the values corresponding to the parameters specified in the relationship formulas and various parameters in the fifth embodiment are also listed.

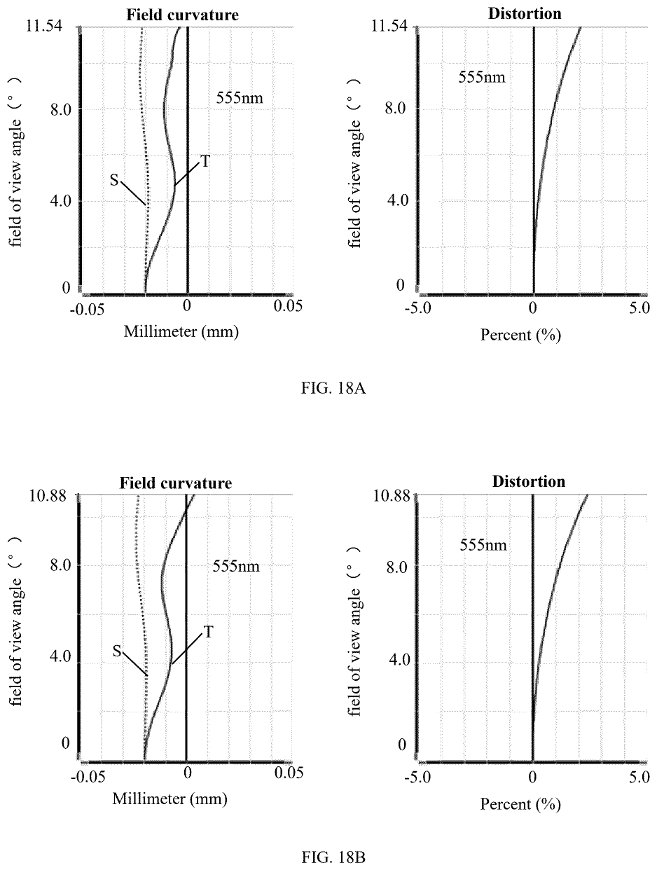

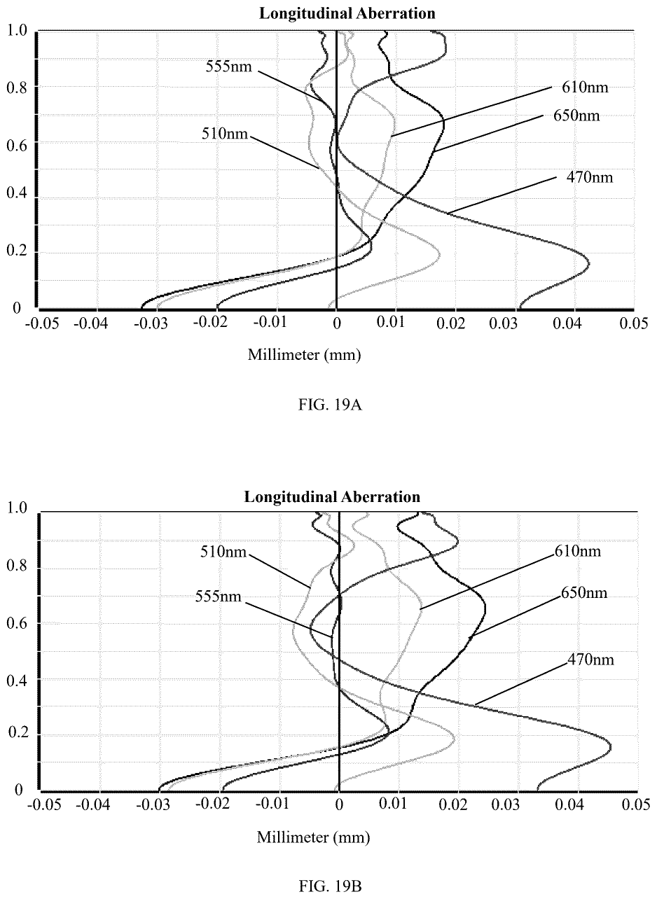

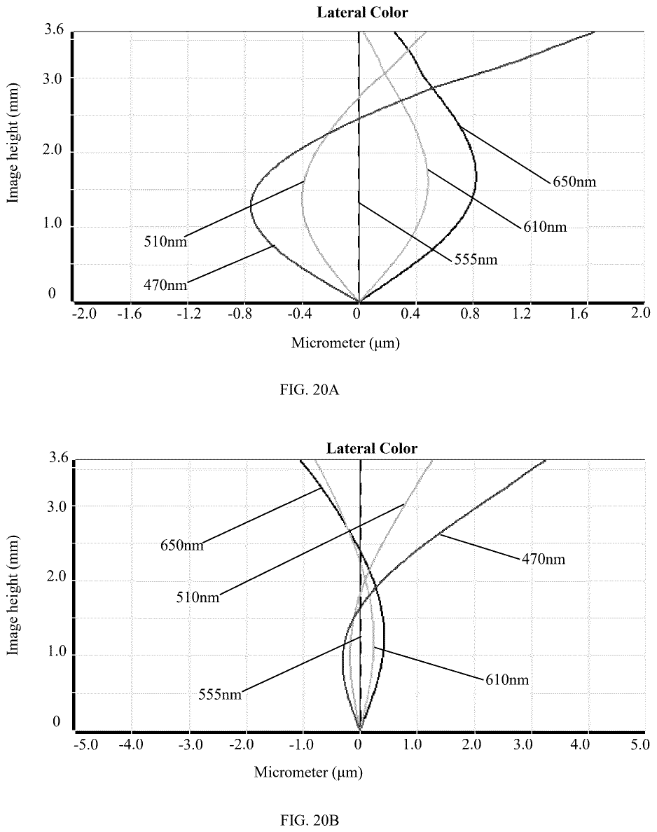

FIG. 18A and FIG. 18B show schematic diagrams of the field curvature and distortion of light with of 555 nm after passing through the imaging optical lens 50 of the fifth embodiment. FIG. 19A and FIG. 19B show schematic diagrams of the longitudinal aberration of light with wavelengths of 470 nm, 510 nm, 555 nm, 610 nm, and 650 nm after passing through the imaging optical lens 50 of the fifth embodiment. FIG. 20A and FIG. 20B show schematic diagrams of the lateral color of light with wavelengths of 470 nm, 510 nm, 555 nm, 610 nm, and 650 nm after passing through the imaging optical lens 50 of the fifth embodiment.

As shown in Table 25, the fifth embodiment satisfies all the relationship formulas.

In an embodiment, the entrance pupil diameter of the imaging optical lens 50 in the first state is 8.000 mm, the full-field image height is 3.600 mm, and the diagonal field of view is 23.08°. The imaging optical lens 50 has the characteristics of a large aperture, long focal length, and miniaturization, with its on-axis and off-axis chromatic aberrations are fully corrected, and excellent optical performance.

### Sixth Embodiment

The first prism P1, has positive refractive power, with its object-side surface being convex in the paraxial region and its image-side surface being convex in the paraxial region;
the first lens L1, has negative refractive power, with its object-side surface being concave in the paraxial region and its image-side surface being convex in the paraxial region;
the second lens L2, has positive refractive power, with its object-side surface being convex in the paraxial region and its image-side surface being convex in the paraxial region;
the third lens L3, has negative refractive power, with its object-side surface being concave in the paraxial region and its image-side surface also being concave in the paraxial region;
the fourth lens L4, has positive refractive power, with its object-side surface being convex in the paraxial region and its image-side surface being convex in the paraxial region; and
the fifth lens L5, has negative refractive power, with its object-side surface being convex in the paraxial region and its image-side surface being concave in the paraxial region.

FIG. 21A and FIG. 21B are schematic diagrams showing the structure of the imaging optical lens 60 in the sixth embodiment. The sixth embodiment is basically the same as the first embodiment, and the meanings of the symbols are the same as those in the first embodiment. Only the differences are listed below.

Tables 16-18 show the design data of the imaging optical lens 60 according to the sixth embodiment of the present invention.

TABLE 16

| | R | d | | nd | | vd | |
|---|---|---|---|---|---|---|---|
| ST | ∞ | d0= | d0 | | | | |
| Rp | 4412.092 | dp1= | 9.800 | nd1 | 1.8052 | vd1 | 40.89 |
| Rp2 | −3739.069 | dp2= | dp2 | | | | |
| R1 | −13.629 | d1= | 4.929 | nd2 | 1.6400 | vd2 | 23.54 |
| R2 | −22.218 | d2= | 0.900 | | | | |
| R3 | 8.731 | d3= | 5.252 | nd3 | 1.5444 | vd3 | 55.82 |
| R4 | −5.350 | d4= | 1.072 | | | | |
| R5 | −11.251 | d5= | 0.900 | nd4 | 1.6153 | vd4 | 25.94 |
| R6 | 5.213 | d6= | 1.310 | | | | |
| R7 | 46.876 | d7= | 0.900 | nd5 | 1.6700 | vd5 | 19.39 |
| R8 | −18.507 | d8= | d8 | | | | |
| R9 | 23.195 | d9= | 1.958 | nd6 | 1.5346 | vd6 | 55.69 |
| R10 | 14.600 | d10= | 5.726 | | | | |
| R11 | ∞ | d11= | 0.210 | ndg | 1.5168 | vdg | 64.17 |
| R12 | ∞ | d12= | 3.501 | | | | |

Herein, dp1=“dp1-01”+“dp1-02”, “dp1-01”=5.0, “dp1-02”=4.8.

Table 17 lists relevant optical parameters of the imaging optical lens 60 in the sixth embodiment of the present disclosure in the first state and the second state respectively.

TABLE 17

| | In the first state | In the second state |
|---|---|---|
| f | 17.956 | 17.611 |
| FOV | 22.20° | 20.90° |
| FNO | 2.25 | 2.38 |
| d0 | −11.854 | −10.457 |
| dp2 | 2.640 | 1.243 |
| d8 | 0.903 | 2.300 |

Table 18 lists the conic coefficients k and aspherical coefficients of the imaging optical lens 60 in the sixth embodiment of the present disclosure.

TABLE 18

| | Conic coefficient | Aspheric coefficient | | | | |
|---|---|---|---|---|---|---|
| | K | A4 | A6 | A8 | A10 | A12 |
| Rp1 | −9.90000E+01 | −1.77660E−05 | 2.60310E−06 | −6.37990E−07 | 7.71270E−08 | −5.58450E−09 |
| Rp2 | 0.00000E+00 | 0.00000E+00 | 0.00000E+00 | 0.00000E+00 | 0.00000E+00 | 0.00000E+00 |
| R1 | 7.30512E+00 | 3.24080E−04 | 1.16310E−04 | −2.83320E−05 | 5.99140E−06 | −8.81740E−07 |
| R2 | 3.69571E+00 | −7.02630E−04 | 2.30180E−04 | −3.11430E−05 | 3.03090E−06 | −2.09130E−07 |
| R3 | −1.76386E+01 | 2.20350E−03 | −6.81900E−05 | 7.28730E−07 | 1.24270E−07 | −1.30940E−08 |
| R4 | −6.23795E+00 | 1.92170E−03 | −2.26160E−04 | 2.15830E−05 | −1.82210E−06 | 1.29580E−07 |
| R5 | −8.96174E+00 | 1.45640E−03 | 3.84540E−04 | −1.61840E−04 | 2.45440E−05 | −2.00860E−06 |
| R6 | −5.84162E+00 | −7.92300E−03 | 2.48390E−03 | −5.10770E−04 | 6.02440E−05 | −4.22870E−06 |
| R7 | 9.62536E+01 | −6.47910E−03 | 1.27400E−03 | −2.58600E−05 | −3.45870E−05 | 6.27430E−06 |
| R8 | −2.08125E+00 | −2.17550E−03 | 6.86270E−04 | −4.50440E−06 | −1.88300E−05 | 3.12230E−06 |
| R9 | −4.52714E+01 | 1.15990E−03 | −8.24930E−05 | 2.23100E−05 | −4.35050E−06 | 5.44730E−07 |
| R10 | −5.30220E+01 | 3.26910E−03 | −3.20210E−04 | 5.09660E−05 | −6.13000E−06 | 5.10110E−07 |
| | Conic coefficient | Aspheric coefficient | | | | |
| | K | A14 | A16 | A18 | A20 | A22 |
| Rp1 | −9.90000E+01 | 2.52720E−10 | −7.00260E−12 | 1.08760E−13 | −7.26690E−16 | 0.00000E+00 |
| Rp2 | 0.00000E+00 | 0.00000E+00 | 0.00000E+00 | 0.00000E+00 | 0.00000E+00 | 0.00000E+00 |
| R1 | 7.30512E+00 | 8.83760E−08 | −5.88750E−09 | 2.49750E−10 | −6.10520E−12 | 6.56240E−14 |
| R2 | 3.69571E+00 | 9.63900E−09 | −2.71290E−10 | 3.72020E−12 | −1.28260E−16 | −4.14380E−16 |
| R3 | −1.76386E+01 | 7.42130E−10 | −2.48450E−11 | 4.39060E−13 | −3.10050E−15 | 0.00000E+00 |
| R4 | −6.23795E+00 | −6.34200E−09 | 1.87550E−10 | −3.00920E−12 | 2.02600E−14 | 0.00000E+00 |
| R5 | −8.96174E+00 | 9.76880E−08 | −2.84230E−09 | 4.58530E−11 | −3.15780E−13 | 0.00000E+00 |
| R6 | −5.84162E+00 | 1.78790E−07 | −4.44230E−09 | 5.92500E−11 | −3.22670E−13 | 0.00000E+00 |
| R7 | 9.62536E+01 | −5.16500E−07 | 2.28510E−08 | −5.26210E−10 | 4.95690E−12 | 0.00000E+00 |
| R8 | −2.08125E+00 | −2.36540E−07 | 9.48850E−09 | −1.93440E−10 | 1.58770E−12 | 0.00000E+00 |
| R9 | −4.52714E+01 | −4.33180E−08 | 2.11070E−09 | −5.75810E−11 | 6.74620E−13 | 0.00000E+00 |
| R10 | −5.30220E+01 | −2.86710E−08 | 1.06790E−09 | −2.57550E−11 | 3.30650E−13 | 0.00000E+00 |

In addition, in the subsequent Table 25, the values corresponding to the parameters specified in the relationship formulas and various parameters in the sixth embodiment are also listed.

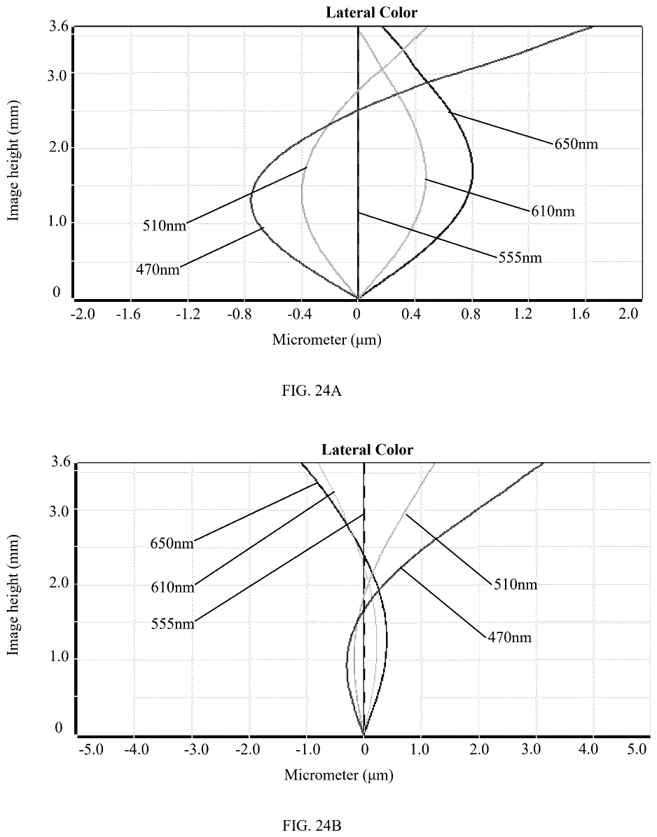

FIG. 22A and FIG. 22B show schematic diagrams of the field curvature and distortion of light with of 555 nm after passing through the imaging optical lens 60 of the sixth embodiment. FIG. 23A and FIG. 23B show schematic diagrams of the longitudinal aberration of light with wavelengths of 470 nm, 510 nm, 555 nm, 610 nm, and 650 nm after passing through the imaging optical lens 60 of the sixth embodiment. FIG. 24A and FIG. 24B show schematic diagrams of the lateral color of light with wavelengths of 470 nm, 510 nm, 555 nm, 610 nm, and 650 nm after passing through the imaging optical lens 60 of the sixth embodiment.

As shown in Table 25, the sixth embodiment satisfies all the relationship formulas.

In an embodiment, the entrance pupil diameter of the imaging optical lens 60 in the first state is 8.000 mm, the full-field image height is 3.600 mm, and the diagonal field of view is 22.20°. The imaging optical lens 60 has the characteristics of a large aperture, long focal length, and miniaturization, with its on-axis and off-axis chromatic aberrations are fully corrected, and excellent optical performance.

### Seventh Embodiment

The first prism P1, has positive refractive power, with its object-side surface being convex in the paraxial region and its image-side surface being convex in the paraxial region;
the first lens L1, has negative refractive power, with its object-side surface being concave in the paraxial region and its image-side surface being convex in the paraxial region;
the second lens L2, has positive refractive power, with its object-side surface being convex in the paraxial region and its image-side surface being convex in the paraxial region;
the third lens L3, has negative refractive power, with its object-side surface being concave in the paraxial region and its image-side surface also being concave in the paraxial region;
the fourth lens L4, has positive refractive power, with its object-side surface being convex in the paraxial region and its image-side surface being convex in the paraxial region; and
the fifth lens L5, has negative refractive power, with its object-side surface being convex in the paraxial region and its image-side surface being concave in the paraxial region.

FIG. 25A and FIG. 25B are schematic diagrams showing the structure of the imaging optical lens 70 in the seventh embodiment. The seventh embodiment is basically the same as the first embodiment, and the meanings of the symbols are the same as those in the first embodiment. Only the differences are listed below.

Tables 19-21 show the design data of the imaging optical lens 70 according to the seventh embodiment of the present invention.

TABLE 19

| | R | d | | nd | | vd | |
|---|---|---|---|---|---|---|---|
| ST | ∞ | d0= | d0 | | | | |
| Rp1 | 138.139 | dp1= | 9.800 | nd1 | 1.8052 | vd1 | 40.91 |
| Rp2 | −113.229 | dp2= | dp2 | | | | |
| R1 | −13.518 | d1= | 4.858 | nd2 | 1.6400 | vd2 | 23.54 |
| R2 | −21.984 | d2= | 0.900 | | | | |
| R3 | 8.938 | d3= | 5.122 | nd3 | 1.5444 | vd3 | 55.82 |
| R4 | −5.463 | d4= | 1.140 | | | | |
| R5 | −11.821 | d5= | 0.900 | nd4 | 1.6153 | vd4 | 25.94 |
| R6 | 5.280 | d6= | 1.277 | | | | |
| R7 | 46.761 | d7= | 0.900 | nd5 | 1.6700 | vd5 | 19.39 |
| R8 | −19.609 | d8= | d8 | | | | |
| R9 | 21.156 | d9= | 2.433 | nd6 | 1.5346 | vd6 | 55.69 |
| R10 | 14.061 | d10= | 5.473 | | | | |
| R11 | ∞ | d11= | 0.210 | ndg | 1.5168 | vdg | 64.17 |
| R12 | ∞ | d12= | 3.248 | | | | |

Herein, dp1=“dp1-01″+” dp1-02″, “dp1-01″=5.0,” dp1-02″=4.8.

Table 20 lists relevant optical parameters of the imaging optical lens 70 in the seventh embodiment of the present disclosure in the first state and the second state respectively.

TABLE 20

| | In the first state | In the second state |
|---|---|---|
| f | 17.857 | 17.541 |
| FOV | 22.32° | 20.96° |
| FNO | 2.23 | 2.37 |
| d0 | −11.917 | −10.457 |
| dp2 | 2.716 | 1.256 |
| d8 | 1.022 | 2.482 |

Table 21 lists the conic coefficients k and aspherical coefficients of the imaging optical lens 70 in the seventh embodiment of the present disclosure.

TABLE 21

| | Conic coefficient | Aspheric coefficient | | | | |
|---|---|---|---|---|---|---|
| | K | A4 | A6 | A8 | A10 | A12 |
| Rp1 | 9.90206E+01 | −1.80000E−05 | 2.34260E−06 | −5.28610E−07 | 5.84900E−08 | −3.78800E−09 |
| Rp2 | 0.00000E+00 | 0.00000E+00 | 0.00000E+00 | 0.00000E+00 | 0.00000E+00 | 0.00000E+00 |
| R1 | 7.30136E+00 | 2.90600E−04 | 1.25070E−04 | −3.15580E−05 | 6.86270E−06 | −1.03530E−06 |
| R2 | 3.95542E+00 | −7.08090E−04 | 2.32230E−04 | −3.01310E−05 | 2.76850E−06 | −1.80400E−07 |
| R3 | −1.76525E+01 | 2.00840E−03 | −3.21370E−05 | −2.46200E−06 | 3.00690E−07 | −1.95550E−08 |
| R4 | −6.25500E+00 | 1.67820E−03 | −1.68320E−04 | 1.50430E−05 | −1.35600E−06 | 1.07150E−07 |
| R5 | −8.83343E+00 | 1.36670E−03 | 4.93450E−04 | −1.92380E−04 | 2.88220E−05 | −2.36290E−06 |
| R6 | −5.64932E+00 | −7.83790E−03 | 2.58120E−03 | −5.48780E−04 | 6.63280E−05 | −4.76720E−06 |
| R7 | 9.57544E+01 | −6.54590E−03 | 1.44460E−03 | −7.48690E−05 | −2.63630E−05 | 5.41450E−06 |
| R8 | −5.99364E+00 | −2.28540E−03 | 7.95900E−04 | −3.86300E−05 | −1.22140E−05 | 2.31890E−06 |
| R9 | −5.00225E+01 | 1.16640E−03 | −7.42480E−05 | 1.64190E−05 | −3.03740E−06 | 3.68050E−07 |
| R10 | −5.93340E+01 | 3.59360E−03 | −3.99930E−04 | 5.94610E−05 | −6.18000E−06 | 3.64550E−07 |
| | Conic coefficient | Aspheric coefficient | | | | |
| | K | A14 | A16 | A18 | A20 | A22 |
| Rp1 | 9.90206E+01 | 1.48720E−10 | −3.42200E−12 | 4.12020E−14 | −1.89070E−16 | 0.00000E+00 |
| Rp2 | 0.00000E+00 | 0.00000E+00 | 0.00000E+00 | 0.00000E+00 | 0.00000E+00 | 0.00000E+00 |
| R1 | 7.30136E+00 | 1.05940E−07 | −7.18100E−09 | 3.09020E−10 | −7.64310E−12 | 8.29260E−14 |
| R2 | 3.95542E+00 | 7.75860E−09 | −1.93080E−10 | 1.69530E−12 | 2.96240E−14 | −6.03770E−16 |
| R3 | −1.76525E+01 | 8.98900E−10 | −2.72490E−11 | 4.59240E−13 | −3.16150E−15 | 0.00000E+00 |
| R4 | −6.25500E+00 | −5.60030E−09 | 1.71240E−10 | −2.79510E−12 | 1.90060E−14 | 0.00000E+00 |
| R5 | −8.83343E+00 | 1.15860E−07 | −3.41220E−09 | 5.58890E−11 | −3.91850E−13 | 0.00000E+00 |
| R6 | −5.64932E+00 | 2.07460E−07 | −5.36440E−09 | 7.58690E−11 | −4.52040E−13 | 0.00000E+00 |
| R7 | 9.57544E+01 | −4.60270E−07 | 2.06150E−08 | −4.76780E−10 | 4.49210E−12 | 0.00000E+00 |
| R8 | −5.99364E+00 | −1.75780E−07 | 6.68450E−09 | −1.20640E−10 | 7.68300E−13 | 0.00000E+00 |
| R9 | −5.00225E+01 | −2.81690E−08 | 1.30950E−09 | −3.37650E−11 | 3.70000E−13 | 0.00000E+00 |
| R10 | −5.93340E+01 | −4.89250E−09 | −7.92890E−10 | 4.92190E−11 | −9.17190E−13 | 0.00000E+00 |

In addition, in the subsequent Table 25, the values corresponding to the parameters specified in the relationship formulas and various parameters in the seventh embodiment are also listed.

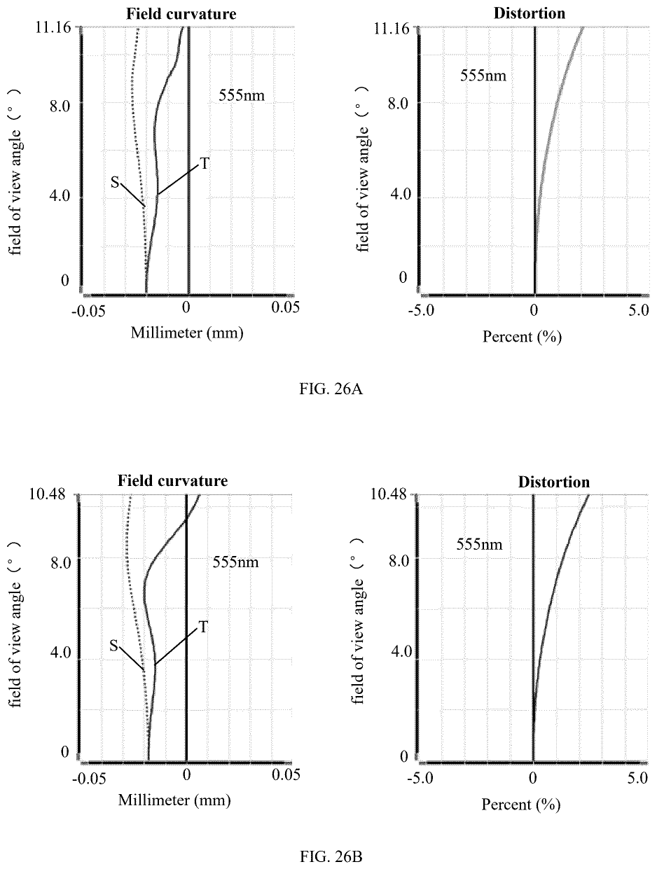

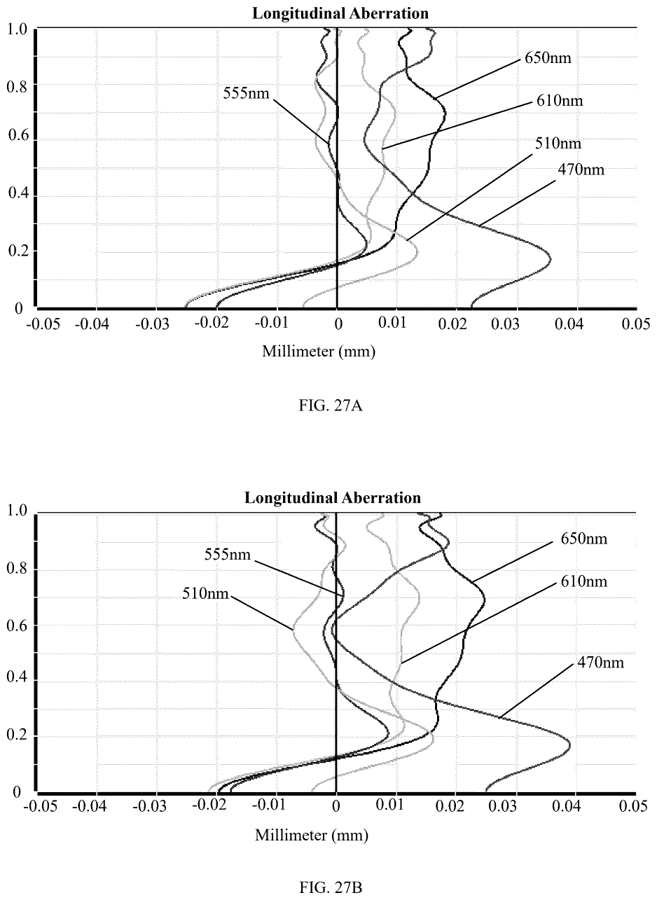

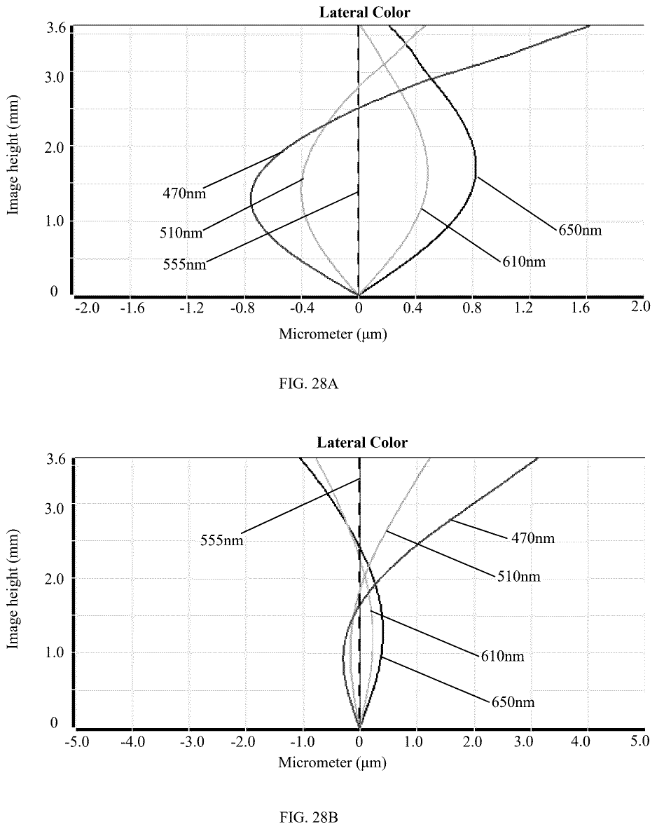

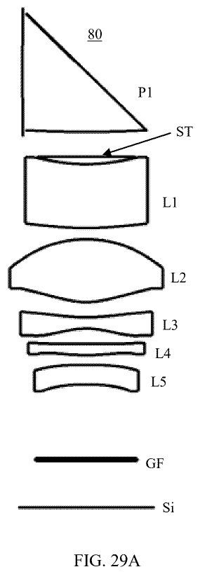

FIG. 26A and FIG. 26B show schematic diagrams of the field curvature and distortion of light with of 555 nm after passing through the imaging optical lens 70 of the seventh embodiment. FIG. 27A and FIG. 27B show schematic diagrams of the longitudinal aberration of light with wavelengths of 470 nm, 510 nm, 555 nm, 610 nm, and 650 nm after passing through the imaging optical lens 70 of the seventh embodiment. FIG. 28A and FIG. 28B show schematic diagrams of the lateral color of light with wavelengths of 470 nm, 510 nm, 555 nm, 610 nm, and 650 nm after passing through the imaging optical lens 70 of the seventh embodiment.

As shown in Table 25, the seventh embodiment satisfies all the relationship formulas.

In an embodiment, the entrance pupil diameter of the imaging optical lens 70 in the first state is 8.000 mm, the full-field image height is 3.600 mm, and the diagonal field of view is 22.32°. The imaging optical lens 70 has the characteristics of a large aperture, long focal length, and miniaturization, with its on-axis and off-axis chromatic aberrations are fully corrected, and excellent optical performance.

### Eighth Embodiment

The first prism P1, has positive refractive power, with its object-side surface being convex in the paraxial region and its image-side surface being convex in the paraxial region;
the first lens L1, has negative refractive power, with its object-side surface being concave in the paraxial region and its image-side surface being convex in the paraxial region;
the second lens L2, has positive refractive power, with its object-side surface being convex in the paraxial region and its image-side surface being convex in the paraxial region;
the third lens L3, has negative refractive power, with its object-side surface being concave in the paraxial region and its image-side surface also being concave in the paraxial region;
the fourth lens L4, has positive refractive power, with its object-side surface being convex in the paraxial region and its image-side surface being convex in the paraxial region; and
the fifth lens L5, has negative refractive power, with its object-side surface being convex in the paraxial region and its image-side surface being concave in the paraxial region.

FIG. 29A and FIG. 29B are schematic diagrams showing the structure of the imaging optical lens 80 in the eighth embodiment. The eighth embodiment is basically the same as the first embodiment, and the meanings of the symbols are the same as those in the first embodiment. Only the differences are listed below.

Tables 22-24 show the design data of the imaging optical lens 80 according to the eighth embodiment of the present invention.

TABLE 22

| | R | d | | nd | | vd | |
|---|---|---|---|---|---|---|---|
| ST | ∞ | d0= | d0 | | | | |
| Rp1 | 223.623 | dp1= | 9.800 | nd1 | 1.8052 | vd1 | 40.91 |
| Rp2 | −86.009 | dp2= | dp2 | | | | |
| R1 | −13.594 | d1= | 5.140 | nd2 | 1.6400 | vd2 | 23.54 |
| R2 | −25.921 | d2= | 0.900 | | | | |
| R3 | 8.320 | d3= | 5.054 | nd3 | 1.5444 | vd3 | 55.82 |
| R4 | −5.650 | d4= | 1.218 | | | | |
| R5 | −13.057 | d5= | 0.900 | nd4 | 1.6153 | vd4 | 25.94 |
| R6 | 5.180 | d6= | 1.239 | | | | |
| R7 | 46.940 | d7= | 0.900 | nd5 | 1.6700 | vd5 | 19.39 |
| R8 | −19.020 | d8= | d8 | | | | |
| R9 | 29.489 | d9= | 1.589 | nd6 | 1.5346 | vd6 | 55.69 |
| R10 | 16.906 | d10= | 5.951 | | | | |
| R11 | ∞ | d11= | 0.210 | ndg | 1.5168 | vdg | 64.17 |
| R12 | ∞ | d12= | 3.725 | | | | |

Herein, dp1=“dp1-01”+“dp1-02”, “dp1-01”=5.0, “dp1-02”=4.8.

Table 23 lists relevant optical parameters of the imaging optical lens 80 in the eighth embodiment of the present disclosure in the first state and the second state respectively.

TABLE 23

| | In the first state | In the second state |
|---|---|---|
| f | 17.980 | 17.979 |
| FOV | 22.20° | 22.20° |
| FNO | 2.25 | 2.25 |
| d0 | −11.803 | −10.455 |
| dp2 | 2.595 | 1.248 |
| d8 | 0.779 | 2.127 |

Table 24 lists the conic coefficients k and aspherical coefficients of the imaging optical lens 80 in the eighth embodiment of the present disclosure.

TABLE 24

| | Conic coefficient | Aspheric coefficient | | | | |
|---|---|---|---|---|---|---|
| | K | A4 | A6 | A8 | A10 | A12 |
| Rp1 | 9.90000E+01 | −1.62630E−05 | 2.47500E−06 | −6.41270E−07 | 7.83290E−08 | −5.68610E−09 |
| Rp2 | 0.00000E+00 | 0.00000E+00 | 0.00000E+00 | 0.00000E+00 | 0.00000E+00 | 0.00000E+00 |
| R1 | 7.30629E+00 | 2.93450E−04 | 1.17070E−04 | −2.76660E−05 | 5.81280E−06 | −8.45130E−07 |
| R2 | 6.25131E+00 | −1.00780E−03 | 2.67810E−04 | −3.46560E−05 | 3.51920E−06 | −2.73510E−07 |
| R3 | −1.63123E+01 | 2.06930E−03 | −6.03900E−05 | 3.35800E−06 | −2.62870E−07 | 1.19450E−08 |
| R4 | −6.13677E+00 | 1.67240E−03 | −1.85670E−04 | 2.03050E−05 | −1.96880E−06 | 1.43970E−07 |
| R5 | −8.49341E+00 | 1.36010E−03 | 5.12540E−04 | −1.97950E−04 | 2.94310E−05 | −2.39530E−06 |
| R6 | −5.53431E+00 | −7.78040E−03 | 2.75800E−03 | −6.13910E−04 | 7.66830E−05 | −5.70190E−06 |
| R7 | 9.49807E+01 | −7.36080E−03 | 1.91750E−03 | −1.88700E−04 | −1.08390E−05 | 4.13210E−06 |
| R8 | −1.14286E+01 | −2.85090E−03 | 1.08940E−03 | −1.08710E−04 | −1.88730E−06 | 1.33740E−06 |
| R9 | −4.10440E+01 | 1.18200E−03 | −1.19540E−04 | 3.69940E−05 | −7.37510E−06 | 9.34600E−07 |
| R10 | −6.17988E+01 | 3.03020E−03 | −3.15400E−04 | 6.41500E−05 | −1.00290E−05 | 1.10850E−06 |
| | Conic coefficient | Aspheric coefficient | | | | |
| | K | A14 | A16 | A18 | A20 | A22 |
| Rp1 | 9.90000E+01 | 2.58410E−10 | −7.21950E−12 | 1.13460E−13 | −7.68990E−16 | 0.00000E+00 |
| Rp2 | 0.00000E+00 | 0.00000E+00 | 0.00000E+00 | 0.00000E+00 | 0.00000E+00 | 0.00000E+00 |
| R1 | 7.30629E+00 | 8.28320E−08 | −5.36160E−09 | 2.20520E−10 | −5.23120E−12 | 5.47480E−14 |
| R2 | 6.25131E+00 | 1.50240E−08 | −5.47630E−10 | 1.23110E−11 | −1.49770E−13 | 7.11500E−16 |
| R3 | −1.63123E+01 | −1.95170E−10 | −3.57040E−12 | 1.62550E−13 | −1.50130E−15 | 0.00000E+00 |
| R4 | −6.13677E+00 | −6.85350E−09 | 1.95300E−10 | −3.02840E−12 | 1.97810E−14 | 0.00000E+00 |
| R5 | −8.49341E+00 | 1.16490E−07 | −3.39590E−09 | 5.49350E−11 | −3.79680E−13 | 0.00000E+00 |
| R6 | −5.53431E+00 | 2.58450E−07 | −7.02890E−09 | 1.05820E−10 | −6.80470E−13 | 0.00000E+00 |
| R7 | 9.49807E+01 | −3.94960E−07 | 1.86100E−08 | −4.42930E−10 | 4.25400E−12 | 0.00000E+00 |
| R8 | −1.14286E+01 | −1.13510E−07 | 4.09410E−09 | −5.69870E−11 | 8.34210E−14 | 0.00000E+00 |
| R9 | −4.10440E+01 | −7.51120E−08 | 3.68660E−09 | −1.00640E−10 | 1.16960E−12 | 0.00000E+00 |
| R10 | −6.17988E+01 | −8.34160E−08 | 4.00820E−09 | −1.09760E−10 | 1.28990E−12 | 0.00000E+00 |

In addition, in the subsequent Table 25, the values corresponding to the parameters specified in the relationship formulas and various parameters in the eighth embodiment are also listed.

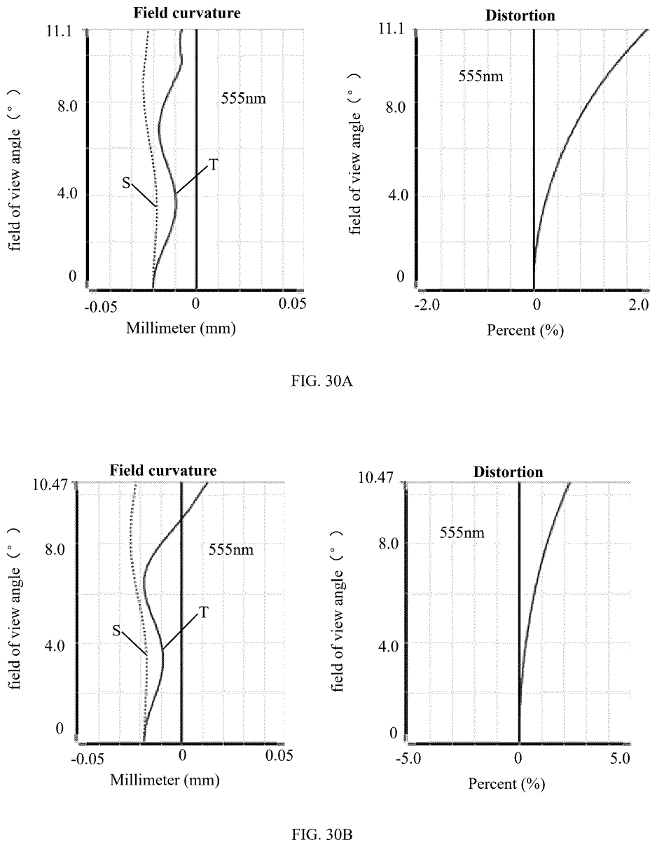

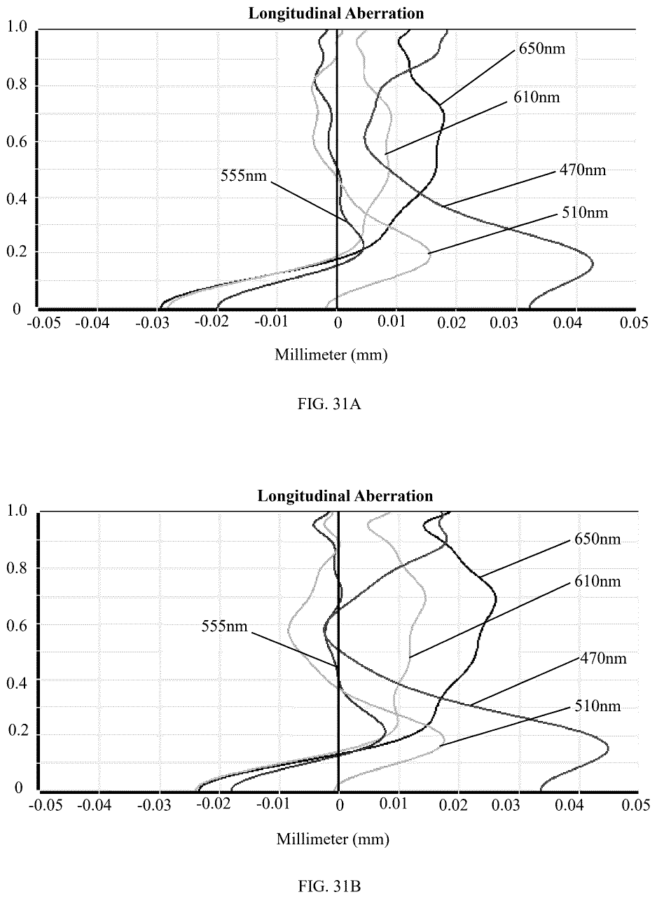

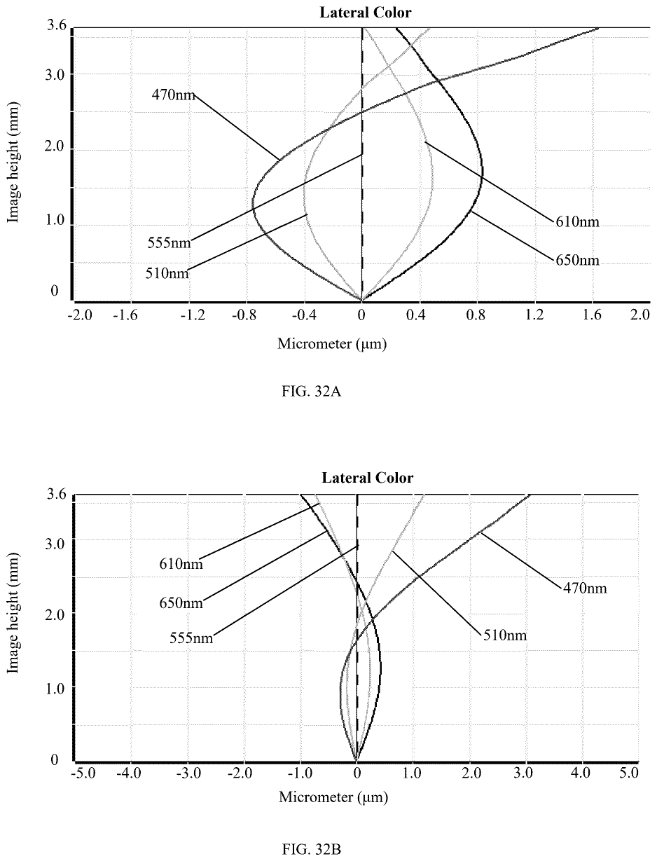

FIG. 30A and FIG. 30B show schematic diagrams of the field curvature and distortion of light with of 555 nm after passing through the imaging optical lens 80 of the eighth embodiment. FIG. 31A and FIG. 31B show schematic diagrams of the longitudinal aberration of light with wavelengths of 470 nm, 510 nm, 555 nm, 610 nm, and 650 nm after passing through the imaging optical lens 80 of the eighth embodiment. FIG. 32A and FIG. 32B show schematic diagrams of the lateral color of light with wavelengths of 470 nm, 510 nm, 555 nm, 610 nm, and 650 nm after passing through the imaging optical lens 80 of the eighth embodiment.

As shown in Table 25, the eighth embodiment satisfies all the relationship formulas.

In an embodiment, the entrance pupil diameter of the imaging optical lens 70 in the first state is 8.000 mm, the full-field image height is 3.600 mm, and the diagonal field of view is 22.20°. The imaging optical lens 80 has the characteristics of a large aperture, long focal length, and miniaturization, with its on-axis and off-axis chromatic aberrations are fully corrected, and excellent optical performance.

TABLE 25

| Parameters Relationship | First | Second | Third |
|---|---|---|---|
| formula | Embodiment | Embodiment | Embodiment |
| fA/IH | 4.97 | 4.94 | 5.07 |
| Rp1/Rp2 | 0.69 | 0.36 | 0.70 |
| f1/d1 | 2.59 | 2.33 | 1.63 |
| BF/TTL | 0.14 | 0.17 | 0.35 |
| f4/R8 − f5/R9 | 0.22 | 1.83 | 3.75 |
| fA | 17.908 | 17.787 | 18.268 |
| fp1 | 98.223 | 89.824 | 455.847 |
| f1 | 15.698 | 14.313 | 8.458 |
| f2 | 6.455 | 5.827 | 3.938 |
| f3 | −5.996 | −4.747 | −2.671 |
| f4 | 68.634 | 41.808 | 20.435 |
| f5 | −57.793 | −71.273 | 213.296 |
| TTL | 40.000 | 40.000 | 40.000 |
| Parameters Relationship | Fourth | Fifth | Sixth |
| formula | Embodiment | Embodiment | Embodiment |
| fA/IH | 4.62 | 4.79 | 4.99 |
| Rp1/Rp2 | 0 | −0.60 | −1.18 |
| f1/d1 | −23.81 | −18.11 | −14.31 |
| BF/TTL | 0.21 | 0.22 | 0.24 |
| f4/R8 − f5/R9 | 4.26 | 3.51 | 2.37 |
| fA | 16.626 | 17.257 | 17.956 |
| fp1 | −452.152 | 51.875 | 2503.773 |
| f1 | −115.243 | −91.931 | −70.537 |
| f2 | 6.650 | 6.737 | 6.996 |
| f3 | −4.992 | −5.266 | −5.632 |
| f4 | 17.617 | 18.779 | 19.732 |
| f5 | −81.404 | −82.465 | −79.806 |
| TTL | 40.000 | 40.000 | 40.001 |

| Parameters Relationship | Seventh | |
|---|---|---|
| formula | Embodiment | Eighth Embodiment |
| fA/IH | 4.96 | 4.99 |
| Rp1/Rp2 | −1.22 | −2.60 |
| f1/d1 | −14.46 | −10.31 |
| BF/TTL | 0.22 | 0.25 |
| f4/R8 − f5/R9 | 3.15 | 1.56 |
| fA | 17.857 | 17.980 |
| fp1 | 78.646 | 78.250 |
| f1 | −70.245 | −52.990 |
| f2 | 7.100 | 7.063 |
| f3 | −5.775 | −5.875 |
| f4 | 20.544 | 20.128 |
| f5 | −88.796 | −77.281 |
| TTL | 39.999 | 40.000 |

The imaging optical lens provided in the embodiments of the present disclosure is introduced in detail above. The principles and implementations of the present disclosure are explained herein by examples. The description of the above embodiments are only used to help understand the idea of the present disclosure. There may be changes in the implementations and the scope of application. In summary, the content of this specification should not be construed as limiting the present disclosure.

What is claimed is:

1. An imaging optical lens, comprising:
in sequence from the object-side to the image-side:
a first prism;
a first lens;
a second lens with positive refractive power;
a third lens with negative refractive power;
a fourth lens with positive refractive power; and
a fifth lens;
wherein:
a reflective surface is arranged between the object-side surface and the image-side surface of the first prism;
the first lens, the second lens, the third lens, and the fourth lens form a first lens group, and the fifth lens forms a second lens group, the first lens group is configured to be movable along the optical axis of the imaging optical lens for adjustment, enabling the imaging optical lens to switch between a first state and a second state, wherein the imaging optical lens has a maximum focal length in the first state and a minimum focal length in the second state;
and wherein:
fA represents a focal length of the imaging optical lens in the first state;
IH represents an image height of the imaging optical lens;
TTL represents a total optical length of the imaging optical lens;
Rp1 represents a curvature radius of the object-side surface of the first prism;
Rp2 represents a curvature radius of the image-side surface of the first prism;
f1 represents a focal length of the first lens;
d1 represents an on-axis thickness of the first lens;
f4 represents a focal length of the fourth lens;
R8 represents a curvature radius of the image-side surface of the fourth lens;
f5 represents a focal length of the fifth lens;
R9 represents a curvature radius of the object-side surface of the fifth lens;
BF represents an on-axis distance from the image-side surface of the fifth lens to the imaging plane of the imaging optical lens in the first state;
and the imaging optical lens satisfies the following relationships:
$$4. \leq fA / IH \leq 5 \text{.10} ; \\ - 4. \leq Rp 1 / Rp 2 \leq 0 \text{.71} ; \\ - 24. 00 \leq f 1 / d 1 \leq 2.6 ; \\ 0.12 \leq BF / TTL \leq 0 \text{.35} ; \\ 0. 20 \leq f 4 / R 8 - f 5 / R 9 \leq 4.30 .$$

2. The imaging optical lens of claim 1, wherein the imaging optical lens satisfies the following relationships:
$$4.61 \leq fA / IH \leq 5 \text{.08} ; \\ - 2.6 \leq Rp 1 / Rp 2 \leq 0 \text{.71} ; \\ - 23. 82 \leq f 1 / d 1 \leq 2.59 ; \\ 0.14 \leq BF / TTL \leq 0 \text{.35} ; \\ 0.21 \leq f 4 / R 8 - f 5 / R 9 \leq 4.26 .$$

3. The imaging optical lens of claim 1, wherein an object-side surface of the first prism is convex or concave in a paraxial region, fp1 represents a focal length of the first prism; and the imaging optical lens satisfies the following relationship:
$$- 27.20 \leq fp 1 / fA \leq 139.44 .$$

4. The imaging optical lens of claim 1, wherein an object-side surface of the first lens is concave in a paraxial region, and an image-side surface of the first lens is convex in a paraxial region;
R1 represents a curvature radius of the object-side surface of the first lens, R2 represents a curvature radius of the image-side surface of the first lens;
and the imaging optical lens further satisfies the following relationships:
$$- 6.94 \leq f 1 / fA \leq 0 \text{.88} ; \\ - 5.98 \leq ( R 1 + R 2 ) / ( R 1 - R 2 ) \leq 2 \text{.67} ; \\ 0.121 \leq d 1 / TTL \leq 0.154 .$$

5. The imaging optical lens of claim 1, wherein an image-side surface of the second lens is convex in a paraxial region;
f2 represents a focal length of the second lens, R3 represents a curvature radius of the object-side surface of the second lens, R4 represents a curvature radius of the image-side surface of the second lens, d3 represents an on-axis thickness of the second lens;
and the imaging optical lens satisfies the following relationships:
$$0.21 \leq f 2 / fA \leq 0 \text{.40} ; \\ 0.19 \leq ( R 3 + R 4 ) / ( R 3 - R 4 ) \leq 2 \text{.02} ; \\ 0.06 \leq d 3 / TTL \leq 0.16 .$$

6. The imaging optical lens of claim 1, wherein an object-side surface of the third lens is concave in a paraxial region, and an image-side surface of the third lens is concave in a paraxial region;
f3 represents a focal length of the third lens, R5 represents a curvature radius of the object-side surface of the third lens, R6 represents a curvature radius of the image-side surface of the third lens, d5 represents an on-axis thickness of the third lens;
and the imaging optical lens satisfies the following relationships:
$$- 0.34 \leq f 3 / fA \leq - 0 \text{.14} ; \\ - 0.63 \leq ( R 5 + R 6 ) / ( R 5 - R 6 ) \leq 0.44 .$$

7. The imaging optical lens of claim 1, wherein an image-side surface of the fourth lens is convex in a paraxial region;
R7 represents a curvature radius of the object-side surface of the fourth lens; d7 represents an on-axis thickness of the fourth lens;
and the imaging optical lens satisfies the following relationships:
$$1.05 \leq f 4 / fA \leq 3.84 ; \\ 0.4 \leq ( R 7 + R 8 ) / ( R 7 - R 8 ) \leq 4 \text{.02} ; \\ 0.022 \leq d 7 / TTL \leq 0.057 .$$

8. The imaging optical lens of claim 1, wherein R9 represents a curvature radius of the object-side surface of the fifth lens, R10 represents a curvature radius of the image-side surface of the fifth lens, d9 represents an on-axis thickness of the fifth lens;
and the imaging optical lens satisfies the following relationships:
$$- 4.98 \leq f 5 / fA \leq 11.68 ; \\ 3. 39 \leq ( R 9 + R 10 ) / ( R 9 - R 10 ) \leq 7.27 ; \\ 0.02 \leq d 9 / TTL \leq 0.21 .$$

9. The imaging optical lens of claim 1, wherein the imaging optical lens has a f-number of FNO in the first state, and the imaging optical lens satisfies the following relationship:
$$2.07 \leq FNO \leq 2.29 .$$

10. The imaging optical lens of claim 1, wherein the first prism is made of glass.
